(19) United States
(12) Patent Application Publication
(10) Pub. No.: US 2017/0374122 A1
(43) Pub. Date: Dec. 28, 2017

(54) Method and Related Apparatus for Providing Media Presentation Guide in Media Streaming Over Hypertext Transfer Protocol

(71) Applicant: Huawei Technologies Co., Ltd., Shenzhen (CN)

(72) Inventors: Shaobo Zhang, Shenzhen (CN); Xin Wang, Shenzhen (CN); Tingfang Tang, Beijing (CN)

(21) Appl. No.: 15/677,436

(22) Filed: Aug. 15, 2017

Related U.S. Application Data
(63) Continuation of application No. PCT/CN2015/073148, filed on Feb. 15, 2015.

(51) Int. Cl. H04L 29/06; H04N 21/439; H04N 21/262; H04N 21/234; H04N 21/233; H04N 21/44; H04L 29/08

(52) U.S. Cl. CPC H04L 65/604; H04N 21/44; H04N 21/439; H04L 67/02; H04N 21/234; H04N 21/233; H04N 21/26283

(57) ABSTRACT

A method and a related apparatus for providing a guide media presentation in media streaming are disclosed. The method include obtaining, by a client, a media presentation description (MPD) of a guide media presentation, where the MPD of the guide media presentation describes N guide units included in the guide media presentation, obtaining K guide units in the N guide units according to the MPD of the guide media presentation, and presenting the K guide units, where each guide unit in the K guide units points to one main media presentation, and presentation quality of a main media presentation to which a guide unit i in the K guide units points is higher than presentation quality of the guide unit i. Solutions support a video guide in an Hypertext Transfer Protocol (HTTP)-based media streaming service scenario and improve user experience.

### CROSS-REFERENCE TO RELATED APPLICATIONS

This application is a continuation of International Patent Application No. PCT/CN2015/073148 filed on Feb. 15, 2015, which is hereby incorporated by reference in its entirety.

### TECHNICAL FIELD

The present application relates to the data transmission field, and to a method and a related apparatus for providing a media presentation guide in media streaming over the Hypertext Transfer Protocol (HTTP).

### BACKGROUND

HTTP-based media streaming multimedia services are increasing, and even posing a challenge to a position of conventional broadcast television. However, some services in conventional television are not supported in HTTP-based media streaming services, and a video guide is one of the services that are not supported. This is indeed a disadvantage.

### SUMMARY

The present application provides a method and a related apparatus for providing a media presentation guide in media streaming over the HTTP in order to support a video guide in an HTTP-based media streaming service scenario and further improve user experience.

According to a first aspect, an embodiment of the present application provides a method for providing a media presentation guide in media streaming over the HTTP, where the method may include obtaining, by a client, a media presentation description (MPD) of a guide media presentation, where the MPD of the guide media presentation describes N guide units included in the guide media presentation, and N is an integer greater than 1, obtaining, by the client, K guide units in the N guide units according to the MPD of the guide media presentation, and presenting, by the client, the K guide units, where each guide unit in the K guide units points to one main media presentation, and presentation quality of a main media presentation to which a guide unit i in the K guide units points is higher than presentation quality of the guide unit i.

With reference to the first aspect, in a first possible implementation of the first aspect, the MPD of the guide media presentation is different from an MPD of the main media presentation to which each guide unit in the K guide units points.

With reference to the first possible implementation of the first aspect, in a second possible implementation of the first aspect, each guide unit in the K guide units points, by pointing to the MPD, to the main media presentation described by the MPD.

With reference to the first aspect, in a third possible implementation of the first aspect, the MPD of the guide media presentation and an MPD of the main media presentation to which each guide unit in the K guide units points are aggregated into one aggregate MPD.

With reference to the third possible implementation of the first aspect, in a fourth possible implementation of the first aspect, each guide unit in the K guide units points to the main media presentation by referencing a presentation element in the aggregate MPD.

With reference to any one of the first aspect, or the first to the fourth possible implementations of the first aspect, in a fifth possible implementation of the first aspect, each guide unit in the N guide units includes a video component, or each guide unit in the N guide units includes an audio component and a video component.

With reference to the fifth possible implementation of the first aspect, in a sixth possible implementation of the first aspect, video components included in different guide units in the K guide units are media representations in different video adaptation sets in K video adaptation sets, selections are exclusive between media representations in any video adaptation set in the K video adaptation sets, and selections are compatible between different video adaptation sets in the K video adaptation sets.

With reference to the sixth possible implementation of the first aspect, in a seventh possible implementation of the first aspect, audio components included in the K guide units are media representations in an audio adaptation set, the audio adaptation set is different from any adaptation set in the K video adaptation sets, and selections are compatible between the audio adaptation set and the K video adaptation sets, or audio components included in different guide units in the K guide units are media representations in different audio adaptation sets in K audio adaptation sets, and selections are exclusive between different audio adaptation sets in the K audio adaptation sets.

With reference to the seventh possible implementation of the first aspect, in an eighth possible implementation of the first aspect, a media representation element in the audio adaptation set element includes a region description of a media representation, which is described by the media representation element, in an associated region in the guide media presentation.

With reference to the eighth possible implementation of the first aspect, in a ninth possible implementation of the first aspect, an association relationship exists between media representations described by media representation elements including a same region description, or an association relationship exists between adaptation sets described by adaptation set elements including a same region description.

With reference to the eighth possible implementation of the first aspect or the ninth possible implementation of the first aspect, in a tenth possible implementation of the first aspect, the region description is a spatial relationship description (SRD).

With reference to any one of the sixth to the tenth possible implementations of the first aspect, in an eleventh possible implementation of the first aspect, the MPD of the guide media presentation includes K video adaptation set elements, and the K video adaptation set elements correspond to the K video adaptation sets on a one-to-one basis, where the K video adaptation set elements include descriptor elements Ci, selections are compatible between video adaptation sets described by video adaptation set elements meeting a specified common condition in the K video adaptation set elements, and the specified common condition is that descriptor elements Ci included in video adaptation set elements have same element names and method identification (schemeIdUri) attributes.

With reference to the eleventh possible implementation of the first aspect, in a twelfth possible implementation of the first aspect, the descriptor element Ci describes a case in which a media representation in a video adaptation set described by a video adaptation set element including the descriptor element Ci is a component of the guide media presentation.

With reference to the eleventh possible implementation of the first aspect, in a thirteenth possible implementation of the first aspect, the descriptor element Ci describes a role of a media representation, in a video adaptation set corresponding to a video adaptation set element including the descriptor element Ci, in the guide media presentation.

With reference to the twelfth possible implementation of the first aspect or the thirteenth possible implementation of the first aspect, in a fourteenth possible implementation of the first aspect, the descriptor element Ci is a role description (Role) element or an essential property (EssentialProptery) element or a supplemental property (SupplementalProptery) element.

With reference to the fourteenth possible implementation of the first aspect, in a fifteenth possible implementation of the first aspect, if the descriptor element Ci is a Role element, the specified common condition is that descriptor elements Ci included in video adaptation set elements have same element names, schemeIdUri attributes, and parameter value attributes.

With reference to any one of the fourth to the fifteenth possible implementations of the first aspect, in a sixteenth possible implementation of the first aspect, the MPD of the guide media presentation includes the K video adaptation set elements, and the K video adaptation set elements correspond to the K video adaptation sets on a one-to-one basis, where a video adaptation set element VI in the K video adaptation set elements that is corresponding to a video adaptation set I includes a pointer for pointing to a main media presentation, and the video adaptation set I is any video adaptation set in the K video adaptation sets.

With reference to the sixteenth possible implementation of the first aspect, in a seventeenth possible implementation of the first aspect, the pointer is carried by an attribute of the video adaptation set element VI.

With reference to the seventeenth possible implementation of the first aspect, in an eighteenth possible implementation of the first aspect, the pointer is carried by an xlink:href attribute of the video adaptation set element VI.

With reference to the sixteenth possible implementation of the first aspect, in a nineteenth possible implementation of the first aspect, the pointer is carried by an EssentialProptery element or a SupplementalProperty element in the video adaptation set element VI.

With reference to the sixteenth possible implementation of the first aspect, in a twentieth possible implementation of the first aspect, the pointer is carried by a child element in an EssentialProptery element in the video adaptation set element VI, or the pointer is carried by an attribute of an EssentialProptery element in the video adaptation set element VI, or the pointer is carried by a child element in a SupplementalProperty element in the video adaptation set element VI, or the pointer is carried by an attribute of a SupplementalProperty element in the video adaptation set element VI.

With reference to the twentieth possible implementation of the first aspect, in a twenty-first possible implementation of the first aspect, the pointer is carried by a value attribute of the EssentialProptery element in the video adaptation set element VI, or the pointer is carried by a value attribute of the SupplementalProperty element in the video adaptation set element VI.

With reference to the sixteenth possible implementation of the first aspect, in a twenty-second possible implementation of the first aspect, the pointer is carried by an attribute of a virtual media representation element in the video adaptation set element VI, or the pointer is carried by a child element in a virtual Representation element in the video adaptation set element VI, where the virtual Representation element does not include a media segment template element, a media segment list element, or a base uniform resource locator (BaseURL) element.

With reference to the sixteenth possible implementation of the first aspect, in a twenty-third possible implementation of the first aspect, the pointer is carried by a referenced media presentation (ReferencedMediaPresentation) element in the video adaptation set element VI.

With reference to any one of the first aspect, or the first to the twenty-third possible implementations of the first aspect, in a twenty-fourth possible implementation of the first aspect, a timeline of the guide media presentation is independent of a timeline of main media presentations to which the K guide units in the guide media presentation point.

With reference to any one of the first aspect, or the first to the twenty-fourth possible implementations of the first aspect, in a twenty-fifth possible implementation of the first aspect, the method further includes presenting, by the client, an audio component of the guide unit i when a focus of attention hovers over the guide unit i in the K guide units.

With reference to any one of the first aspect, or the first to the twenty-fifth possible implementations of the first aspect, in a twenty-sixth possible implementation of the first aspect, the method further includes obtaining, by the client, the main media presentation to which the guide unit i points when the guide unit i in the K guide units is selected.

It may be learned that, in the technical solutions of the embodiments, each guide unit in K guide units may point to one main media presentation, and this is equivalent to a specific association relationship introduced between the guide unit and the main media presentation. Therefore, when a guide unit i in the K guide units is selected, the client may obtain an MPD of a main media presentation j to which the guide unit i points, and may further obtain the main media presentation j according to the MPD of the main media presentation j and perform presenting. Evidently, this implements relatively flexible switching between a guide media presentation and a main media presentation, further supports a video guide in an HTTP-based media streaming service scenario, and further improves user experience.

### BRIEF DESCRIPTION OF DRAWINGS

To describe the technical solutions in the embodiments of the present application more clearly, the following briefly describes the accompanying drawings required for describing the embodiments. The accompanying drawings in the following description show merely some embodiments of the present application, and persons of ordinary skill in the art may still derive other drawings from these accompanying drawings without creative efforts.

FIG. 1A is a schematic diagram of an architecture of an MPD according to an embodiment of the present application;

FIG. 1B is a schematic flowchart of a method for providing a media presentation guide in media streaming over HTTP according to an embodiment of the present application;

FIG. 1C is a schematic diagram of a timeline of a single media presentation according to an embodiment of the present application;

FIG. 1D is a schematic diagram of timelines of multiple media presentations according to an embodiment of the present application;

FIG. 1E and FIG. 1F are schematic diagrams of media representations of guide units that are obtained by encoding according to an embodiment of the present application;

FIG. 1G is a schematic diagram of another timeline of multiple media presentations according to an embodiment of the present application;

FIG. 1H is a schematic diagram of another timeline of multiple media presentations according to an embodiment of the present application;

FIG. 1I is a schematic diagram of a guide media presentation obtained by synthesis according to an embodiment of the present application;

FIG. 1J is a schematic diagram of video components of guide units that are output by a client after decoding according to an embodiment of the present application;

FIG. 1K is a schematic diagram of audio components of guide units that are output by a client after decoding according to an embodiment of the present application;

FIG. 2 is a schematic flowchart of another method for providing a media presentation guide in media streaming over HTTP according to an embodiment of the present application;

FIG. 3A is a schematic flowchart of another method for providing a media presentation guide in media streaming over HTTP according to an embodiment of the present application;

FIG. 3B is a schematic diagram of a network architecture according to an embodiment of the present application;

FIG. 4 is a schematic diagram of a client according to an embodiment of the present application;

FIG. 5 is a schematic diagram of another client according to an embodiment of the present application;

FIG. 6 is a schematic diagram of a server according to an embodiment of the present application;

FIG. 7 is a schematic diagram of another server according to an embodiment of the present application; and

FIG. 8 is a schematic diagram of a communications system according to an embodiment of the present application.

### DESCRIPTION OF EMBODIMENTS

Embodiments of the present application provide a method and a related apparatus for providing a media presentation guide in media streaming over the HTTP in order to support a video guide in an HTTP-based media streaming service scenario and further improve user experience.

The following clearly describes the technical solutions in the embodiments of the present application with reference to the accompanying drawings in the embodiments of the present application. application

In the specification, claims, and accompanying drawings of the present application, the terms “first,” “second,” “third,” “fourth,” and so on are intended to distinguish between different objects but do not indicate a particular order. In addition, the terms “include,” “contain,” and any other variant thereof, are intended to cover a non-exclusive inclusion. For example, a process, a method, a system, a product, or a device that includes a series of steps or units is not limited to the listed steps or units, but optionally further includes an unlisted step or unit, or optionally further includes another inherent step or unit of the process, the method, the product, or the device.

For better understanding the technical solutions of the embodiments of the present application, the following first describes some possible related technologies.

In a conventional analog television service, a user may search for a channel of interest by switching between different channels, and then keeps watching the channel of interest. In a digital television service, an electronic program guide (EPG) may be provided. The EPG is actually a list. The EPG includes information such as programs and times of different channels. The user may search for a television channel of interest from the EPG, and then switch to the channel from the EPG. It is found through practice that, a guide service provided in a graphical manner is more user-friendly and easy-to-use.

In the guide service, a guide unit represents a television channel. Like the television channel represented by the guide unit, the guide unit may have different media components, such as a video and an audio. The graphical guide service presents videos of a group of guide units in a form of multiple thumbnails (a moving picture sequence or static pictures). The user may browse multiple thumbnails, and change a guide unit of interest. The user may even listen to an audio of a current guide unit of interest. By selecting a guide unit, the user may switch to a channel corresponding to the guide unit.

With development of technologies, especially broadband communications and microprocessors, communication capabilities and functions of personal devices are stronger, and online multimedia streaming services on the Internet are increasingly popular. An HTTP-based adaptive streaming service becomes a mainstream technology of a multimedia streaming service, and represents latest development of the field. HTTP streaming (HLS) of Apple Inc., Smooth Streaming (SS) of Microsoft Corporation, and Dynamic Adaptive Streaming over HTTP (DASH) of the Moving Picture Experts Group (MPEG) are different forms of the technology. A DASH standard of the MPEG is a standardization technology developed by the MPEG, and is expected to be widely used so as to change a segmented market pattern.

It is a pity that the guide service cannot be supported in an existing HTTP-based media streaming service. The existing HTTP-based media streaming service is applicable only to one media presentation (the media presentation is a term used in the DASH standard, and is approximately equivalent to a television channel conceptually), but a guide service serves multiple media presentations, and is a service crossing multiple media presentations. The present application is intended to support the guide service in the HTTP-based media streaming service. Although the present application cites a term in the DASH standard as a basis of descriptions and the embodiments, the method in the present application is not limited to the DASH standard, but may be applied to multiple HTTP-based media streaming services.

Optionally, technical solutions of some embodiments of the present application may be based on, for example, the following DASH specification and supplements and amendments thereof:

International Standards Organization/International Electrotechnical Commission (ISO/IEC) 23009-1: Part 1: Media presentation description and segment formats, 2nd Edition, 2014.

ISO/IEC 23009-1:2014/FDAM 1.

Part 1: Media presentation description and segment formats.

AMENDMENT 1: High Profile and Availability Time Synchronization Extended profiles and time synchronization.

ISO/IEC 23009-1:2014/DAM 2.

Part 1: Media presentation description and segment formats.

AMENDMENT 2: Spatial Relationship Description, Generalized URL parameters and other extensions.

In the DASH standard, one piece of media content is encoded into multiple versions, and the versions have different features, such as a bit rate. The versions are referred to as media representations in the DASH, represent same media content, and may replace each other from a perspective of a content presentation (view/play). A media representation is divided in time into accessible units, generally with a length of several seconds, and the units are referred to as media segments or media sub-segments (a media segment may be divided into media sub-segments logically). In addition, there is an initialization segment. The initialization segment includes only metadata, without media data. Hereinafter, both the media segment and the initialization segment are referred to as segments. The media representation is stored on a content server, such as an HTTP server, for obtaining by a client. The segment is a minimum unit that the client can access using a uniform resource locator (URL). An MPD is an Extensible Markup Language (XML) file, includes metadata required by the client, describes a feature of a media representation and how to obtain the media representation from the server, and includes a bit rate and resolution of the media representation, a length-width ratio of a video picture, a URL of a segment included in the media representation, and the like. Based on information in the MPD, the client may construct an HTTP URL to request a media segment in the media representation from the content server, and may switch to another media representation at a media segment boundary to adapt to a change of an available bandwidth.

The HTTP-based adaptive media streaming service allows a change of a content feature in a media presentation, for example, a change of a media encoding mode. In the DASH standard, this is implemented using a “period” concept. A period is used for content stitching. For example, a current period is a news program, and a next period is an advertisement. One media presentation includes one or more periods, and the periods are sequential in time. A period start means a change relative to a previous period, for example, a change of content, for example, from a news program to a sports program, from a sports program to a movie program, from a movie program to an advertisement, or from an advertisement to a variety show, a change of a content encoding mode, for example, from an H.264 coding scheme to an H.265 coding scheme, a change of a quantity of media representations, for example, an increase or a decrease of media representations, or a change of a content component, for example, adding of a Chinese audio representation. When the client encounters a start of a new period, a working condition of the client changes, and re-initialization may be required.

In a period, a set of media representations including same media content and a same media component is referred to as an adaptation set. One adaptation set includes at least one media representation, and media representations in one adaptation set may replace each other. Different adaptation sets may be compatible or exclusive.

In summary, a media presentation may include one or more periods that are sequential in time, and each period includes one or more adaptation sets. Each adaptation set includes one or more media representations. One media representation includes one or more segments.

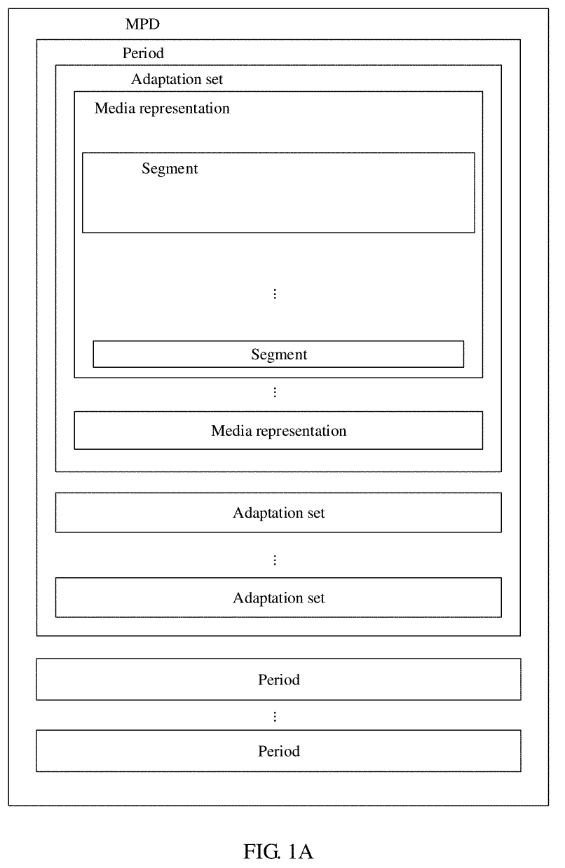

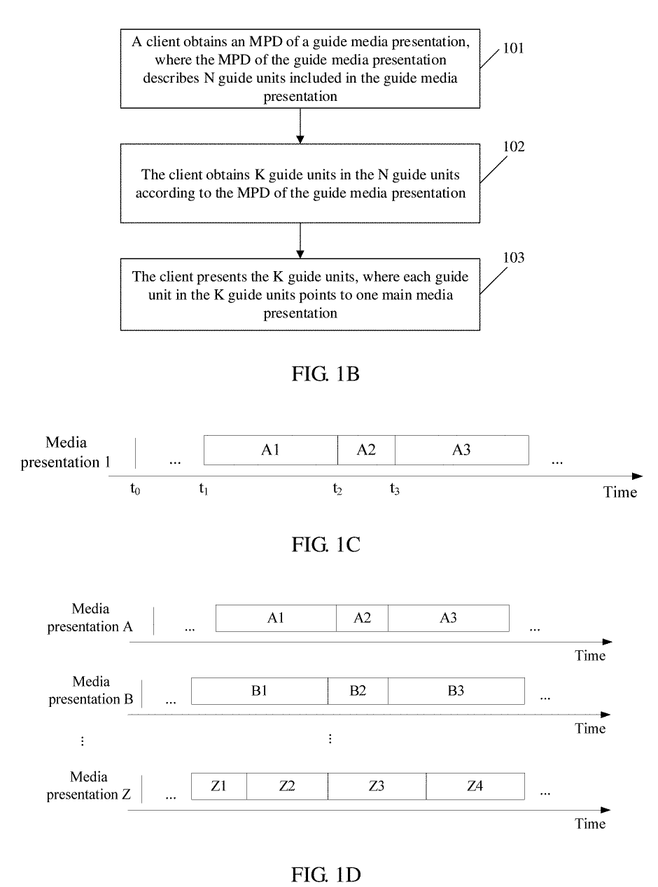

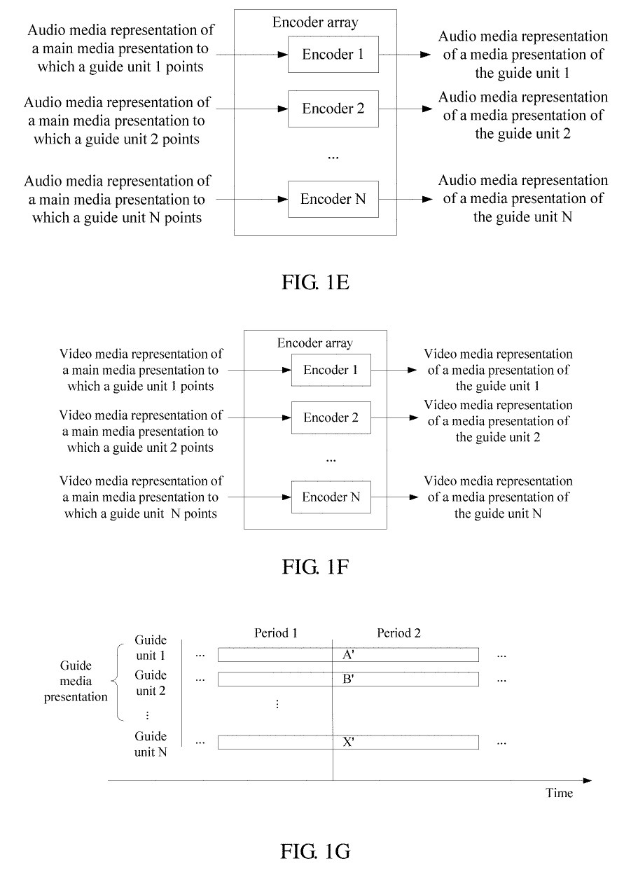

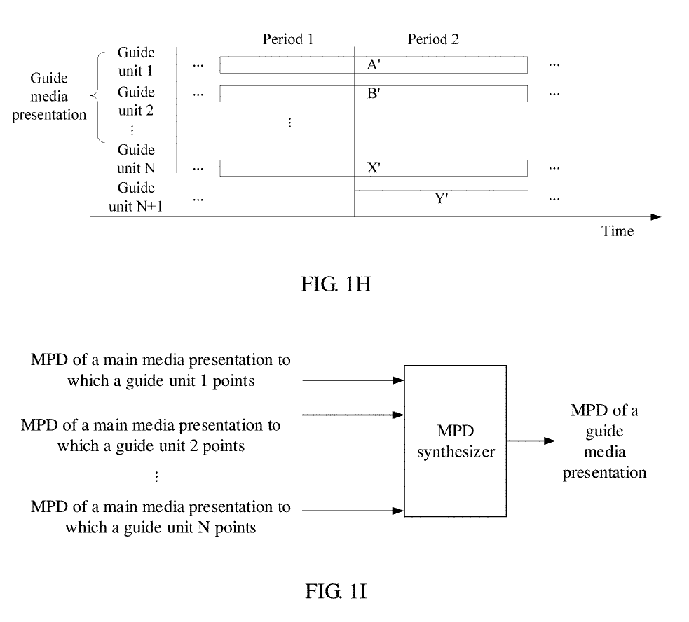

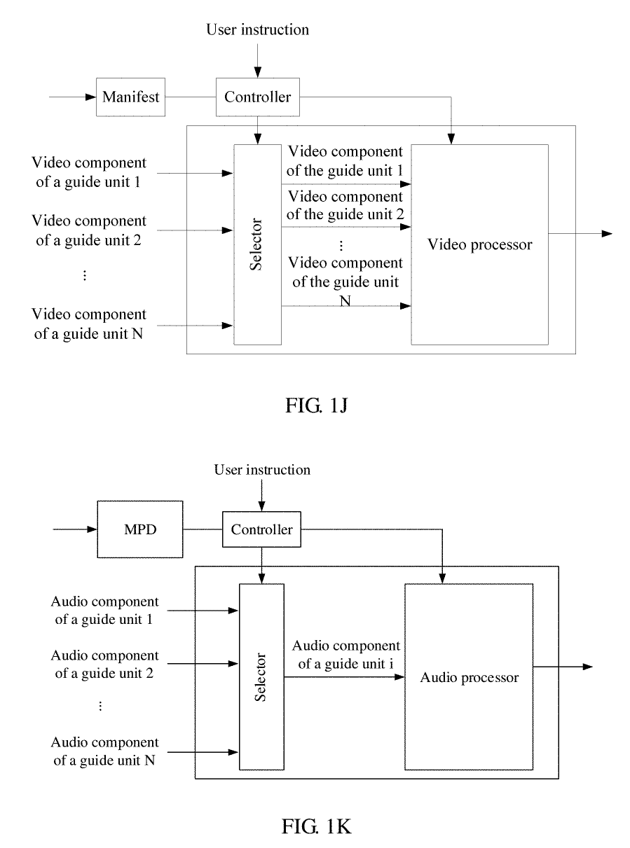

An MPD has a hierarchical structure similar to that of a media presentation, as shown in FIG. 1A. The media presentation described above may be represented by an XML element in an MPD. A media presentation element includes one or more period elements, and each period element includes one or more adaptation set elements. Each adaptation set element includes one or more media representation elements.

A media presentation corresponds to an MPD element in an MPD. One period in the media presentation corresponds to one period element in the MPD, one adaptation set in the media presentation corresponds to one adaptation set element in the MPD, one media representation in the media presentation corresponds to one media representation element in the MPD, and so on.

The following describes a method for providing a media presentation guide in media streaming over HTTP.

A guide service serves multiple media presentations, provides convenience for selection from a group of media presentations, and is a service crossing multiple media presentations. The multiple media presentations served by the guide service are referred to as member media presentations of the guide service, and are member media presentations or main media presentations for short.

In the technical solutions of the embodiments of the present application, a guide service may be implemented by a media presentation (namely, a guide media presentation), and the guide media presentation is independent of member media presentations of the guide service. The guide service and the member media presentations of the guide service are described by respective MPDs. If the guide service serves N media presentations, there are N+1 media presentations and N+1 corresponding MPDs. In the guide service, each member media presentation corresponds to one guide unit in the guide media presentation, and the guide unit represents the member media presentation. The guide service and the member media presentations of the guide service are described by the respective MPDs. One guide unit represents one media presentation, and may include multiple media components, typically for example, video components (which may also be referred to as video media representations) and audio components (which may also be referred to as audio media representations). A video of a guide unit is a thumbnail, and represents a media presentation. The video of the guide unit is usually obtained by tailoring a video component of the media presentation represented by the guide unit, and therefore, is a part of a picture. Presentation quality (for example, resolution and/or a frame rate) of the guide unit is lower than that of a main media presentation, and an audio of the guide unit comes from an audio of the main media presentation. In the present application, a video of one guide unit is implemented by one or more media representations (one media presentation, for example).

Referring to FIG. 1B, FIG. 1B is a schematic flowchart of a method for providing a media presentation guide in media streaming over HTTP according to an embodiment of the present application. As shown in FIG. 1B, the method for providing a media presentation guide in media streaming over HTTP provided in this embodiment of the present application may include the following steps.

Step 101: A client obtains an MPD of a guide media presentation, where the MPD of the guide media presentation describes N guide units included in the guide media presentation.

The client may obtain the MPD of the guide media presentation from a content server or another device.

N is an integer greater than 1.

For example, N may be equal to 7, 2, 3, 4, 5, 8, 11, 15, 20, 25, 30, or another value.

The client may be a DASH client, or another client having a DASH client logic function, or another client of an HTTP-based media streaming service.

For example, the client may be a personal computer, a mobile phone, a tablet computer, a television set, or a set top box.

The guide media presentation may be considered as a special media presentation.

Step 102: The client obtains K guide units in N guide units according to the MPD of the guide media presentation.

K is a positive integer less than or equal to N.

For example, K may be equal to 1, 2, 3, 4, 5, 8, 11, 15, 20, 25, 30, or another value.

The K guide units may correspond to K logical presentation units (for example, the logical presentation units may be guide windows) on a one-to-one basis, that is, all the guide units in the K guide units may be presented by different logical presentation units.

Step 103: The client presents the K guide units, where each guide unit in the K guide units points to one main media presentation. Presentation quality of a main media presentation to which a guide unit i in the K guide units points is higher than presentation quality of the guide unit i.

That is, presentation quality of a media representation of a guide unit is lower than presentation quality of a main media presentation represented by the guide unit.

Optionally, in some possible implementations of the present application, the MPD of the guide media presentation may be different from an MPD of the main media presentation to which each guide unit in the K guide units points. That is, the guide media presentation may have an independent MPD, and the main media presentation to which each guide unit in the K guide units points may also have an independent MPD that is different from the MPD of the guide media presentation. For example, the K guide units point to K main media presentations, and the K main media presentations respectively have corresponding MPDs, namely, K MPDs, but the MPD of the guide media presentation is different from any one of the K MPDs, that is, the guide media presentation may be described by a (K+1)^{th} MPD.

In addition, in other possible implementations of the present application, the MPD of the guide media presentation and an MPD of the main media presentation to which each guide unit in the K guide units points may be aggregated into one aggregate MPD (or referred to as a super MPD). That is, an aggregate MPD (or referred to as a super MPD) may be used to describe the guide media presentation and the main media presentation to which the guide media presentation points. Introduction of the super MPD enhances an association relationship between the guide media presentation and the main media presentation to which each guide unit points.

In an actual application, the guide unit may point to the main media presentation in a quite flexible manner. The guide unit may directly point to the main media presentation or may indirectly point to the main media presentation.

For example, each guide unit in the K guide units may point, by pointing to the MPD, to the main media presentation described by the MPD. Certainly, the guide unit may point to the main media presentation in another direct pointing or indirect pointing manner. For example, the MPD of the guide media presentation and the MPD of the main media presentation to which each guide unit in the K guide units points may be aggregated into one aggregate MPD. In this case, each guide unit in the K guide units may point to the main media presentation by referencing a presentation element in the aggregate MPD.

Optionally, in some possible implementations of the present application, each guide unit in the N guide units includes a video component, or each guide unit in the N guide units includes an audio component and a video component. Further, the guide unit may include a caption component or another type of media components.

The present application provides a guide service signaling mechanism using an MPD (such as an MPD in the DASH standard). The MPD may notify the client of guide units included in a guide service, components of the guide units, a relationship between the guide units and member media presentations of the guide service, a relationship between video components of the guide units, a relationship between audio components of the guide units, a relationship between the audio components and the video components of the guide units, and the like.

Optionally, in some possible implementations of the present application, video components included in different guide units in the K guide units are media representations in different video adaptation sets in K video adaptation sets, selections are exclusive between media representations in any video adaptation set in the K video adaptation sets, and selections are compatible between different video adaptation sets in the K video adaptation sets. For example, a video component included in the guide unit i in the K guide units may belong to a video adaptation set Ci in the K video adaptation sets, and a video component included in a guide unit j in the K guide units may belong to a video adaptation set Cj in the K video adaptation sets. The video adaptation set Cj and the video adaptation set Ci are two different video adaptation sets in the K video adaptation sets. The guide unit j and the guide unit i may be any two guide units in the K guide units.

That selections are compatible means that the objects may be selected together. For example, if selections are compatible between different video adaptation sets in the K video adaptation sets, it indicates that media representations in multiple video adaptation sets in the K video adaptation sets may be selected together.

That selections are exclusive means that the objects cannot be selected together. For example, if selections are exclusive between media representations in any video adaptation set in the K video adaptation sets, it indicates that multiple media representations in one video adaptation set cannot be selected together. For example, assuming that a video adaptation set I in the K video adaptation sets includes 10 media representations, if selections are exclusive between the media representations in the video adaptation set, only one of the 10 media representations can be selected every time, and multiple media representations in the 10 media representations cannot be selected together.

Optionally, in some possible implementations of the present application, audio components included in the K guide units are media representations in an audio adaptation set, the audio adaptation set is different from any adaptation set in the K video adaptation sets, and selections are compatible between the audio adaptation set and the K video adaptation sets. For example, assuming that the audio adaptation set includes 20 media representations, if selections are exclusive between the media representations in the audio adaptation set, only one of the 20 media representations can be selected every time, and multiple media representations in the 20 media representations cannot be selected together.

Optionally, in other possible implementations of the present application, audio components included in different guide units in the K guide units are media representations in different audio adaptation sets in K audio adaptation sets, and selections are exclusive between different audio adaptation sets in the K audio adaptation sets.

Optionally, in some possible implementations of the present application, a media representation element in the audio adaptation set element may include a region description of a media representation, which is described by the media representation element, in an associated region in the guide media presentation.

Optionally, in some possible implementations of the present application, an association relationship exists between media representations described by media representation elements including a same region description, or an association relationship exists between adaptation sets described by adaptation set elements including a same region description. For example, a media representation described by a media representation element i is a media representation ri, and a media representation described by a media representation element j is a media representation rj, if the media representation element i and the media representation element j include a same region description, it may indicate that an association relationship exists between the media representation ri and the media representation rj.

Optionally, in some possible implementations of the present application, if the media representation element i and an adaptation set element ci include a same region description, it may also indicate that an association relationship exists between the media representation described by the media representation element i and each media representation in an adaptation set described by the adaptation set element ci. For example, the media representation described by the media representation element i may be an audio media representation, but the media representation in the adaptation set described by the adaptation set element ci may be a video media representation.

Optionally, in some possible implementations of the present application, the region description may be an SRD. Certainly, the region description may be another type of description information that may be used for describing a region of a guide unit in the guide media presentation.

Optionally, in some possible implementations of the present application, the MPD of the guide media presentation includes K video adaptation set elements, and the K video adaptation set elements correspond to the K video adaptation sets on a one-to-one basis.

The K video adaptation set elements include descriptor elements Ci, selections are compatible between video adaptation sets described by video adaptation set elements meeting a specified common condition in the K video adaptation set elements, and the specified common condition may be, for example, that descriptor elements Ci included in video adaptation set elements have same element names and schemeIdUri attributes.

Optionally, in some possible implementations of the present application, the descriptor element Ci may describe a case in which a media representation in a video adaptation set described by a video adaptation set element including the descriptor element Ci is a component of the guide media presentation. Alternatively, the descriptor element Ci may describe a role of a media representation, in a video adaptation set corresponding to a video adaptation set element including the descriptor element Ci, in the guide media presentation. For example, the role may be main, supplementary, caption, or dub.

Optionally, in some possible implementations of the present application, the descriptor element Ci may be, for example, an EssentialProptery element or a SupplementalProptery element or a Role element or another element.

Optionally, in some possible implementations of the present application, if the descriptor element Ci is a Role element, the specified common condition may be that descriptor elements Ci included in video adaptation set elements may have same element names, schemeIdUri attributes, and parameter (value) attributes.

Optionally, in some possible implementations of the present application, the MPD of the guide media presentation includes the K video adaptation set elements, and the K video adaptation set elements correspond to the K video adaptation sets on a one-to-one basis. A video adaptation set element VI in the K video adaptation set elements that is corresponding to a video adaptation set I includes a pointer for pointing to a main media presentation, and the video adaptation set I may be any video adaptation set in the K video adaptation sets.

A position in which the pointer is carried in the video adaptation set element VI may be determined according to a requirement.

For example, the pointer may be carried by an attribute of the video adaptation set element VI.

Further, for example, the pointer may be carried by an xlink:href attribute or another attribute of the video adaptation set element VI.

For another example, the pointer may be carried by an EssentialProptery element or a SupplementalProperty element in the video adaptation set element VI.

Further, for example, the pointer may be carried by a child element in an EssentialProptery element in the video adaptation set element VI, or the pointer may be carried by an attribute of an EssentialProptery element in the video adaptation set element VI, or the pointer may be carried by a child element in a SupplementalProperty element in the video adaptation set element VI, or the pointer may be carried by an attribute of a SupplementalProperty element in the video adaptation set element VI.

Further, for example, the pointer may be carried by a value attribute or another attribute of the EssentialProptery element in the video adaptation set element VI, or the pointer may be carried by a value attribute or another attribute of the SupplementalProperty element in the video adaptation set element VI.

For another example, the pointer may be carried by an attribute of a virtual Representation element in the video adaptation set element VI, or the pointer may be carried by a child element in a virtual Representation element in the video adaptation set element VI, where the virtual Representation element does not include a media segment template element, a media segment list element, or a BaseURL element.

For another example, the pointer may be carried by a ReferencedMediaPresentation element in the video adaptation set element VI. The ReferencedMediaPresentation element is a newly extended element. That is, the newly extended element in the video adaptation set element VI may be used to carry the pointer. A name of the newly extended element that carries the pointer and that is in the video adaptation set element VI is not limited to ReferencedMediaPresentation, and may be another element name.

Optionally, in some possible implementations of the present application, a timeline of the guide media presentation may be independent of a timeline of main media presentations to which the K guide units in the guide media presentation point. An audio of a guide unit may be obtained by encoding an audio of a main media presentation, and a video of the guide unit may be obtained by encoding a video of the main media presentation. Therefore, no correlation exists between a timeline of the guide unit and a timeline of the main media presentation.

The following illustrates a timeline of a media presentation with reference to accompanying drawings.

The following illustrates a timeline of a media presentation with reference to FIG. 1C and FIG. 1D.

FIG. 1C illustrates a timeline of a media presentation 1. The media presentation includes several consecutive periods (designated as A1, A2, and A3).

FIG. 1D illustrates timelines of multiple media presentations (designated as media presentation A, media presentation B, . . . , and media presentation Z). Each media presentation includes several consecutive periods (designated as A1, A2, and A3 for media presentation A, designated as B1, B2, and B3 for media presentation B, and designated as Z1, Z2, Z3, and Z4 for media presentation Z. However, the timelines of the multiple media presentations are different. For example, boundaries of the periods are not aligned. The media presentations are sequential in time, and MPDs also describe sequential timelines. However, description of non-sequential timelines of multiple concurrent media presentations exceeds a capability of a conventional MPD.

In this embodiment of the present application, recoding processing may be performed again on a media representation (an audio, a video, and the like) of the main media presentation to which each guide unit points, to obtain a media representation of the guide unit. That is, the media representation of the main media presentation to which each guide unit points and the media representation of the guide unit are independent. In addition, media representations of all the guide units are independent, and audio components and video components of a same guide unit are also independent. Therefore, a media representation of a guide media presentation is not affected by a period arrangement of media representations of corresponding main media presentations. FIG. 1E and FIG. 1F show examples of modes of encoding, by the content server, video media representations and audio media representations of main media presentations to which guide units point.

FIG. 1G shows an example of period arrangements of media presentations of the N guide units in the guide media presentation. The period arrangements of the media presentations of the N guide units in the guide media presentation are aligned. FIG. 1H shows that when a guide unit is newly added, period arrangements of media presentations of the newly added guide unit and other guide units are aligned.

FIG. 1I shows an example of a manner of obtaining the MPD of the guide media presentation by the content server using the MPD of the main media presentation to which each guide unit points. Certainly, the content server may obtain the MPD of the guide media presentation in another manner.

FIG. 1J and FIG. 1K show examples of selecting the K guide units by the client for presenting. Video media representations of the K guide units in the N guide units are decoded and presented, and an audio media representation of a highlighted guide unit in audio media representations of the K guide units is decoded and presented. Certainly, the client may select, based on the MPD of the guide media presentation and a user instruction, a specific manner of presenting the K guide units.

Optionally, in some possible implementations of the present application, the method further includes presenting, by the client, an audio component of the guide unit i when a focus of attention hovers over the guide unit i in the K guide units.

Optionally, in some possible implementations of the present application, the method further includes obtaining, by the client, the main media presentation to which the guide unit i points when the guide unit i in the K guide units is selected. Further, the client may present the main media presentation to which the guide unit i points.

It may be learned that, in the technical solution of this embodiment, each guide unit in K guide units may point to one main media presentation, and this is equivalent to a specific association relationship introduced between the guide unit and the main media presentation. Therefore, when a guide unit i in the K guide units is selected, the client may obtain an MPD of a main media presentation j to which the guide unit i points, and may further obtain the main media presentation j according to the MPD of the main media presentation j and perform presenting. Evidently, this implements relatively flexible switching between a guide media presentation and a main media presentation, further supports a video guide in an HTTP-based media streaming service scenario, and further improves user experience.

The technical solution of this embodiment of the present application makes a guide service more flexible. The present application can implement a personalized guide service. For example, a guide service may be configured on a client. For example, a quantity of guide units displayed on a guide page or in a guide window, a combination of guide units, presentation positions and a presentation sequence of the guide units, and the like may all be configured on the client. This is greatly helpful in using the guide service on different diversified devices, for example, a mobile phone terminal and a tablet computer. Capabilities of the devices such as display sizes, resolution, and computing capabilities are different.

In addition, a communication bandwidth is used more effectively. In a conventional television service, all media streams, including a guide unit stream and a main media stream, are transmitted together to a terminal (a television set or a set top box). Transmitting all media streams is impossible for a media streaming service, because a bandwidth that can be used by a client is limited and is far less than that in a broadcast system. In addition, because a user usually uses only some guide units, or because a user's interest is limited, for example, a user is interested only in a sports program, or because a communication capability of the terminal is limited, or because a user finds a desired program channel and does not continue to use the guide, many guide units do not need to be transmitted. In the present application, a guide unit may be transmitted only when the guide unit is required by the client. This also avoids unnecessary bandwidth occupancy.

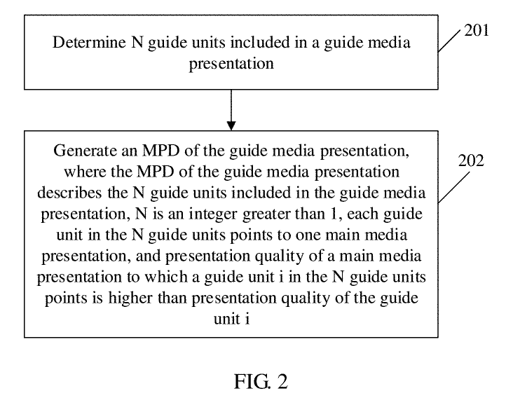

Referring to FIG. 2, FIG. 2 is a schematic flowchart of another method for providing a media presentation guide in media streaming over HTTP according to another embodiment of the present application. As shown in FIG. 2, the method for providing a media presentation guide in media streaming over HTTP provided in the other embodiment of the present application may include the following steps.

Step 201: Determine N guide units included in a guide media presentation.

Step 202: Generate an MPD of the guide media presentation, where the MPD of the guide media presentation describes the N guide units included in the guide media presentation, N is an integer greater than 1, each guide unit in the N guide units points to one main media presentation, and presentation quality of a main media presentation to which a guide unit i in the N guide units points is higher than presentation quality of the guide unit i.

This embodiment of the present application may be executed by a content server or another device. The content server may store the MPD of the guide media presentation, and may provide the MPD for a client.

The MPD of the guide media presentation describes the N guide units included in the guide media presentation.

The client may obtain the MPD of the guide media presentation from the content server or another device.

N is an integer greater than 1.

For example, N may be equal to 7, 2, 3, 4, 5, 8, 11, 15, 20, 25, 30, or another value.

The client may be a DASH client, or another client having a DASH client logic function, or another client of an HTTP-based media streaming service.

For example, the client may be a personal computer, a mobile phone, a tablet computer, a television set, or a set top box.

The guide media presentation may be considered as a special media presentation.

It may be learned that, in the technical solution of this embodiment, an MPD of a guide media presentation describes N guide units included in the guide media presentation. Each guide unit in the N guide units may point to one main media presentation, and this is equivalent to a specific association relationship introduced between the guide unit and the main media presentation. Therefore, when a guide unit i in the N guide units is selected on a client, the client may obtain an MPD of a main media presentation j to which the guide unit i points, and may further obtain the main media presentation j according to the MPD of the main media presentation j and perform presenting. Evidently, this solution lays a basis for implementing relatively flexible switching between the guide media presentation and the main media presentation, and further lays a basis for supporting a video guide in an HTTP-based media streaming service scenario.

The presentation quality of the main media presentation to which the guide unit i in the N guide units points is higher than the presentation quality of the guide unit i. That is, presentation quality of a media representation of a guide unit is lower than presentation quality of a main media presentation represented by the guide unit.

Optionally, in some possible implementations of the present application, the MPD of the guide media presentation may be different from an MPD of the main media presentation to which each guide unit in the N guide units points. That is, the guide media presentation may have an independent MPD, and the main media presentation to which each guide unit in the N guide units points may also have an independent MPD that is different from the MPD of the guide media presentation. For example, the N guide units point to N main media presentations, and the N main media presentations respectively have corresponding MPDs, namely, N MPDs, but the MPD of the guide media presentation is different from any one of the N MPDs, that is, the guide media presentation may be described by an (N+1)th MPD.

In addition, in other possible implementations of the present application, the MPD of the guide media presentation and an MPD of the main media presentation to which each guide unit in the N guide units points may be aggregated into one aggregate MPD (or referred to as a super MPD). That is, an aggregate MPD (or referred to as a super MPD) may be used to describe the guide media presentation and the main media presentation to which the guide media presentation points. Introduction of the super MPD enhances an association relationship between the guide media presentation and the main media presentation to which each guide unit points.

In an actual application, the guide unit may point to the main media presentation in a quite flexible manner. The guide unit may directly point to the main media presentation or may indirectly point to the main media presentation.

For example, each guide unit in the N guide units may point, by pointing to the MPD, to the main media presentation described by the MPD. Certainly, the guide unit may point to the main media presentation in another direct pointing or indirect pointing manner. For example, the MPD of the guide media presentation and the MPD of the main media presentation to which each guide unit in the N guide units points may be aggregated into one aggregate MPD. In this case, each guide unit in the N guide units may point to the main media presentation by referencing a presentation element in the aggregate MPD.

Optionally, in some possible implementations of the present application, each guide unit in the N guide units includes a video component, or each guide unit in the N guide units includes an audio component and a video component. Further, the guide unit may include a caption component or another type of media components.

The present application provides a guide service signaling mechanism using an MPD (such as an MPD in the DASH standard). The MPD may notify the client of guide units included in a guide service, components of the guide units, a relationship between the guide units and member media presentations of the guide service, a relationship between video components of the guide units, a relationship between audio components of the guide units, a relationship between the audio components and the video components of the guide units, and the like.

Optionally, in some possible implementations of the present application, video components included in different guide units in the N guide units are media representations in different video adaptation sets in N video adaptation sets, selections are exclusive between media representations in any video adaptation set in the N video adaptation sets, and selections are compatible between different video adaptation sets in the N video adaptation sets. For example, a video component included in the guide unit i in the N guide units may belong to a video adaptation set Ci in the N video adaptation sets, and a video component included in a guide unit j in the N guide units may belong to a video adaptation set Cj in the N video adaptation sets. The video adaptation set Cj and the video adaptation set Ci are two different video adaptation sets in the N video adaptation sets. The guide unit j and the guide unit i may be any two guide units in the N guide units.

That selections are compatible means that the objects may be selected together. For example, if selections are compatible between different video adaptation sets in the N video adaptation sets, it indicates that media representations in multiple video adaptation sets in the N video adaptation sets may be selected together.

That selections are exclusive means that the objects cannot be selected together. For example, if selections are exclusive between media representations in any video adaptation set in the N video adaptation sets, it indicates that multiple media representations in one video adaptation set cannot be selected together. For example, assuming that a video adaptation set I in the N video adaptation sets includes 10 media representations, if selections are exclusive between the media representations in the video adaptation set, only one of the 10 media representations can be selected every time, and multiple media representations in the 10 media representations cannot be selected together.

Optionally, in some possible implementations of the present application, audio components included in the N guide units are media representations in an audio adaptation set, the audio adaptation set is different from any adaptation set in the N video adaptation sets, and selections are compatible between the audio adaptation set and the N video adaptation sets. For example, assuming that the audio adaptation set includes 20 media representations, if selections are exclusive between the media representations in the audio adaptation set, only one of the 20 media representations can be selected every time, and multiple media representations in the 20 media representations cannot be selected together.

Optionally, in other possible implementations of the present application, audio components included in different guide units in the N guide units are media representations in different audio adaptation sets in N audio adaptation sets, and selections are exclusive between different audio adaptation sets in the N audio adaptation sets.

Optionally, in some possible implementations of the present application, a media representation element in the audio adaptation set element may include a region description of a media representation, which is described by the media representation element, in an associated region in the guide media presentation.

Optionally, in some possible implementations of the present application, an association relationship exists between media representations described by media representation elements including a same region description, or an association relationship exists between adaptation sets described by adaptation set elements including a same region description. For example, a media representation described by a media representation element i is a media representation ri, and a media representation described by a media representation element j is a media representation rj, and if the media representation element i and the media representation element j include a same region description, it may indicate that an association relationship exists between the media representation ri and the media representation rj.

Optionally, in some possible implementations of the present application, if the media representation element i and an adaptation set element ci include a same region description, it may also indicate that an association relationship exists between the media representation described by the media representation element i and each media representation in an adaptation set described by the adaptation set element ci. For example, the media representation described by the media representation element i may be an audio media representation, but the media representation in the adaptation set described by the adaptation set element ci may be a video media representation.

Optionally, in some possible implementations of the present application, the region description may be an SRD. Certainly, the region description may be another type of description information that may be used for describing a region of a guide unit in the guide media presentation.

Optionally, in some possible implementations of the present application, the MPD of the guide media presentation includes N video adaptation set elements, and the N video adaptation set elements correspond to the N video adaptation sets on a one-to-one basis.

The N video adaptation set elements include descriptor elements Ci, selections are compatible between video adaptation sets described by video adaptation set elements meeting a specified common condition in the N video adaptation set elements, and the specified common condition may be, for example, that descriptor elements Ci included in video adaptation set elements have same element names and schemeIdUri attributes.

Optionally, in some possible implementations of the present application, the descriptor element Ci may describe a case in which a media representation in a video adaptation set described by a video adaptation set element including the descriptor element Ci is a component of the guide media presentation. Alternatively, the descriptor element Ci may describe a role of a media representation, in a video adaptation set corresponding to a video adaptation set element including the descriptor element Ci, in the guide media presentation. For example, the role may be main, supplementary, caption, or dub of translation.

Optionally, in some possible implementations of the present application, the descriptor element Ci may be, for example, an EssentialProptery element or a SupplementalProptery element or a Role element or another element.

Optionally, in some possible implementations of the present application, if the descriptor element Ci is a Role element, the specified common condition may be that descriptor elements Ci included in video adaptation set elements may have same element names, schemeIdUri attributes, and parameter (value) attributes.

Optionally, in some possible implementations of the present application, the MPD of the guide media presentation includes the N video adaptation set elements, and the N video adaptation set elements correspond to the N video adaptation sets on a one-to-one basis. A video adaptation set element VI in the N video adaptation set elements that is corresponding to a video adaptation set I includes a pointer for pointing to a main media presentation, and the video adaptation set I may be any video adaptation set in the N video adaptation sets.

A position in which the pointer is carried in the video adaptation set element VI may be determined according to a requirement of a scenario.

For example, the pointer may be carried by an attribute of the video adaptation set element VI.

Further, for example, the pointer may be carried by an xlink:href attribute or another attribute of the video adaptation set element VI.

For another example, the pointer may be carried by an EssentialProptery element or a SupplementalProperty element in the video adaptation set element VI.

Further, for example, the pointer may be carried by a child element in an EssentialProptery element in the video adaptation set element VI, or the pointer may be carried by an attribute of an EssentialProptery element in the video adaptation set element VI, or the pointer may be carried by a child element in a SupplementalProperty element in the video adaptation set element VI, or the pointer may be carried by an attribute of a SupplementalProperty element in the video adaptation set element VI.

Further, for example, the pointer may be carried by a value attribute or another attribute of the EssentialProptery element in the video adaptation set element VI, or the pointer may be carried by a value attribute or another attribute of the SupplementalProperty element in the video adaptation set element VI.

For another example, the pointer may be carried by an attribute of a virtual Representation element in the video adaptation set element VI, or the pointer may be carried by a child element in a virtual Representation element in the video adaptation set element VI, where the virtual Representation element does not include a media segment template element, a media segment list element, or a BaseURL element.

For another example, the pointer may be carried by a ReferencedMediaPresentation element in the video adaptation set element VI. The ReferencedMediaPresentation element is a newly extended element. That is, the newly extended element in the video adaptation set element VI may be used to carry the pointer. A name of the newly extended element that carries the pointer and that is in the video adaptation set element VI is not limited to ReferencedMediaPresentation, and may be another element name.

Optionally, in some possible implementations of the present application, a timeline of the guide media presentation may be independent of a timeline of main media presentations to which the N guide units in the guide media presentation point. An audio of a guide unit may be obtained by encoding an audio of a main media presentation, and a video of the guide unit may be obtained by encoding a video of the main media presentation. Therefore, no correlation exists between a timeline of the guide unit and a timeline of the main media presentation.

For better understanding and implementing the foregoing solutions of the embodiments of the present application, the following uses examples for description with reference to some specific application scenarios.

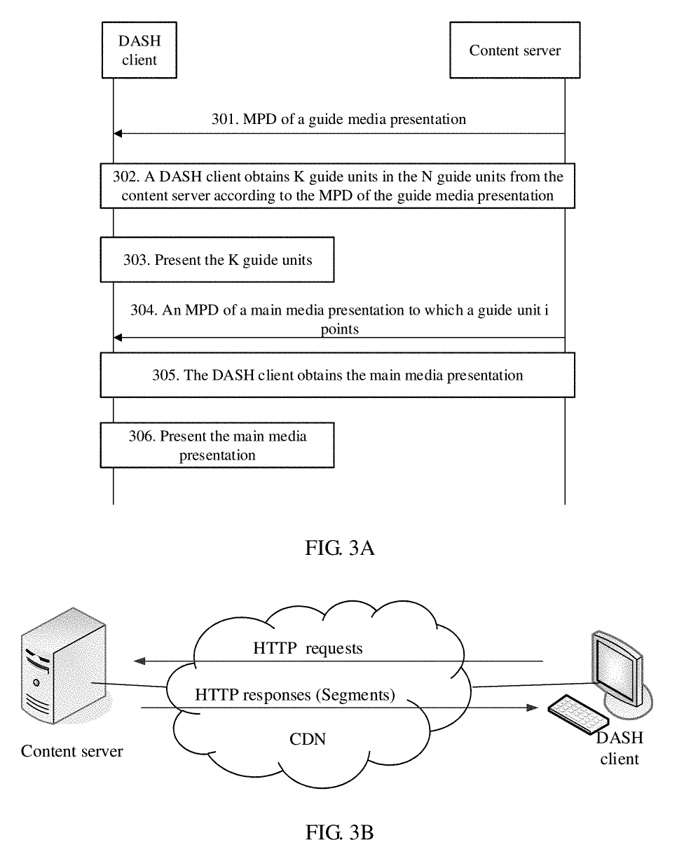

Referring to FIG. 3A and FIG. 3B, FIG. 3A is a schematic flowchart of a method for providing a media presentation guide in media streaming over HTTP according to another embodiment of the present application. The method, shown in FIG. 3A, for providing a media presentation guide in media streaming over HTTP may be further implemented based on a network architecture shown in FIG. 3B. The network architecture shown in FIG. 3B mainly includes a DASH client, a content server, content delivery network (CDN), and the like.

As shown in FIG. 3A, the method for providing a media presentation guide in media streaming over HTTP provided in the other embodiment of the present application may include the following steps.

Step 301: A DASH client obtains an MPD of a guide media presentation from a content server.

The MPD of the guide media presentation describes N guide units included in the guide media presentation.

N is an integer greater than 1.

For example, N may be equal to 7, 2, 3, 4, 5, 8, 11, 15, 20, 25, 30, or another value.

For example, the DASH client may be a personal computer, a mobile phone, a tablet computer, a television set, or a set top box.

Step 302: The DASH client obtains K guide units in the N guide units from the content server according to the MPD of the guide media presentation.

K is a positive integer less than or equal to N.

For example, K may be equal to 1, 2, 3, 4, 5, 8, 11, 15, 20, 25, 30, or another value.

The K guide units may correspond to K logical presentation units on a one-to-one basis, that is, all the guide units in the K guide units may be presented by different logical presentation units.

Step 303: The DASH client presents the K guide units.

Each guide unit in the K guide units may point to one main media presentation.

Presentation quality of a main media presentation to which a guide unit i in the K guide units points is higher than presentation quality of the guide unit i. That is, presentation quality of a media representation of a guide unit is lower than presentation quality of a main media presentation represented by the guide unit.

Step 304: When a guide unit i in the K guide units is selected, the DASH client obtains, from the content server, an MPD of a main media presentation to which the guide unit i points.

Step 305: The DASH client obtains the main media presentation from the content server based on the MPD of the main media presentation.

Step 306: The DASH client presents the main media presentation to which the guide unit i points.

The presentation quality of the main media presentation to which the guide unit i in the K guide units points is higher than the presentation quality of the guide unit i. That is, presentation quality of a media representation of a guide unit is lower than presentation quality of a main media presentation represented by the guide unit.

Optionally, in some possible implementations of the present application, the MPD of the guide media presentation may be different from an MPD of the main media presentation to which each guide unit in the K guide units points. That is, the guide media presentation may have an independent MPD, and the main media presentation to which each guide unit in the K guide units points may also have an independent MPD that is different from the MPD of the guide media presentation. For example, the K guide units point to K main media presentations, and the K main media presentations respectively have corresponding MPDs, namely, K MPDs, but the MPD of the guide media presentation is different from any one of the K MPDs, that is, the guide media presentation may be described by a (K+1)th MPD.

In addition, in other possible implementations of the present application, the MPD of the guide media presentation and an MPD of the main media presentation to which each guide unit in the K guide units points may be aggregated into one aggregate MPD (or referred to as a super MPD). That is, an aggregate MPD (or referred to as a super MPD) may be used to describe the guide media presentation and the main media presentation to which the guide media presentation points. Introduction of the super MPD enhances an association relationship between the guide media presentation and the main media presentation to which each guide unit points.

In an actual application, the guide unit may point to the main media presentation in a quite flexible manner. The guide unit may directly point to the main media presentation or may indirectly point to the main media presentation.

For example, each guide unit in the K guide units may point, by pointing to the MPD, to the main media presentation described by the MPD. Certainly, the guide unit may point to the main media presentation in another direct pointing or indirect pointing manner. For example, the MPD of the guide media presentation and the MPD of the main media presentation to which each guide unit in the K guide units points may be aggregated into one aggregate MPD. In this case, each guide unit in the K guide units may point to the main media presentation by referencing a presentation element in the aggregate MPD.

Optionally, in some possible implementations of the present application, each guide unit in the N guide units includes a video component, or each guide unit in the N guide units includes an audio component and a video component. Further, the guide unit may include a caption component or another type of media components.

The present application provides a guide service signaling mechanism using an MPD (such as an MPD in the DASH standard). The MPD may notify the client of guide units included in a guide service, components of the guide units, a relationship between the guide units and member media presentations of the guide service, a relationship between video components of the guide units, a relationship between audio components of the guide units, a relationship between the audio components and the video components of the guide units, and the like.

Optionally, in some possible implementations of the present application, video components included in different guide units in the K guide units are media representations in different video adaptation sets in K video adaptation sets, selections are exclusive between media representations in any video adaptation set in the K video adaptation sets, and selections are compatible between different video adaptation sets in the K video adaptation sets. For example, a video component included in the guide unit i in the K guide units may belong to a video adaptation set Ci in the K video adaptation sets, and a video component included in a guide unit j in the K guide units may belong to a video adaptation set Cj in the K video adaptation sets. The video adaptation set Cj and the video adaptation set Ci are two different video adaptation sets in the K video adaptation sets. The guide unit j and the guide unit i may be any two guide units in the K guide units.

That selections are compatible means that the objects may be selected together. For example, if selections are compatible between different video adaptation sets in the K video adaptation sets, it indicates that media representations in multiple video adaptation sets in the K video adaptation sets may be selected together.

That selections are exclusive means that the objects cannot be selected together. For example, if selections are exclusive between media representations in any video adaptation set in the K video adaptation sets, it indicates that multiple media representations in one video adaptation set cannot be selected together. For example, assuming that a video adaptation set I in the K video adaptation sets includes 10 media representations, if selections are exclusive between the media representations in the video adaptation set, only one of the 10 media representations can be selected every time, and multiple media representations in the 10 media representations cannot be selected together.

Optionally, in some possible implementations of the present application, audio components included in the K guide units are media representations in an audio adaptation set, the audio adaptation set is different from any adaptation set in the K video adaptation sets, and selections are compatible between the audio adaptation set and the K video adaptation sets. For example, assuming that the audio adaptation set includes 20 media representations, if selections are exclusive between the media representations in the audio adaptation set, only one of the 20 media representations can be selected every time, and multiple media representations in the 20 media representations cannot be selected together.

Optionally, in other possible implementations of the present application, audio components included in different guide units in the K guide units are media representations in different audio adaptation sets in K audio adaptation sets, and selections are exclusive between different audio adaptation sets in the K audio adaptation sets.

Optionally, in some possible implementations of the present application, a media representation element in the audio adaptation set element may include a region description of a media representation, which is described by the media representation element, in an associated region in the guide media presentation.

Optionally, in some possible implementations of the present application, an association relationship exists between media representations described by media representation elements including a same region description, or an association relationship exists between adaptation sets described by adaptation set elements including a same region description. For example, a media representation described by a media representation element i is a media representation ri, and a media representation described by a media representation element j is a media representation rj, if the media representation element i and the media representation element j include a same region description, it may indicate that an association relationship exists between the media representation ri and the media representation rj.

Optionally, in some possible implementations of the present application, if the media representation element i and an adaptation set element ci include a same region description, it may also indicate that an association relationship exists between the media representation described by the media representation element i and each media representation in an adaptation set described by the adaptation set element ci. For example, the media representation described by the media representation element i may be an audio media representation, but the media representation in the adaptation set described by the adaptation set element ci may be a video media representation.

Optionally, in some possible implementations of the present application, the region description may be an SRD. Certainly, the region description may be another type of description information that may be used for describing a region of a guide unit in the guide media presentation.

Optionally, in some possible implementations of the present application, the MPD of the guide media presentation includes K video adaptation set elements, and the K video adaptation set elements correspond to the K video adaptation sets on a one-to-one basis.

The K video adaptation set elements include descriptor elements Ci, selections are compatible between video adaptation sets described by video adaptation set elements meeting a specified common condition in the K video adaptation set elements, and the specified common condition may be, for example, that descriptor elements Ci included in video adaptation set elements have same element names and schemeIdUri attributes.

Optionally, in some possible implementations of the present application, the descriptor element Ci may describe a case in which a media representation in a video adaptation set described by a video adaptation set element including the descriptor element Ci is a component of the guide media presentation. Alternatively, the descriptor element Ci may describe a role of a media representation, in a video adaptation set corresponding to a video adaptation set element including the descriptor element Ci, in the guide media presentation. For example, the role may be main, supplementary, caption, or dub of translation.

Optionally, in some possible implementations of the present application, the descriptor element Ci may be, for example, an EssentialProptery element or a SupplementalProptery element or a Role element or another element.

Optionally, in some possible implementations of the present application, if the descriptor element Ci is a Role element, the specified common condition may be that descriptor elements Ci included in video adaptation set elements may have same element names, schemeIdUri attributes, and parameter (value) attributes.

Optionally, in some possible implementations of the present application, the MPD of the guide media presentation includes the K video adaptation set elements, and the K video adaptation set elements correspond to the K video adaptation sets on a one-to-one basis. A video adaptation set element VI in the K video adaptation set elements that is corresponding to a video adaptation set I includes a pointer for pointing to a main media presentation, and the video adaptation set I may be any video adaptation set in the K video adaptation sets.

A position in which the pointer is carried in the video adaptation set element VI may be determined according to a requirement of a scenario.

For example, the pointer may be carried by an attribute of the video adaptation set element VI.

Further, for example, the pointer may be carried by an xlink:href attribute or another attribute of the video adaptation set element VI.

For another example, the pointer may be carried by an EssentialProptery element or a SupplementalProperty element in the video adaptation set element VI.

Further, for example, the pointer may be carried by a child element in an EssentialProptery element in the video adaptation set element VI, or the pointer may be carried by an attribute of an EssentialProptery element in the video adaptation set element VI, or the pointer may be carried by a child element in a SupplementalProperty element in the video adaptation set element VI, or the pointer may be carried by an attribute of a SupplementalProperty element in the video adaptation set element VI.

Further, for example, the pointer may be carried by a value attribute or another attribute of the EssentialProptery element in the video adaptation set element VI, or the pointer may be carried by a value attribute or another attribute of the SupplementalProperty element in the video adaptation set element VI.

For another example, the pointer may be carried by an attribute of a virtual Representation element in the video adaptation set element VI, or the pointer may be carried by a child element in a virtual Representation element in the video adaptation set element VI, where the virtual Representation element does not include a media segment template element, a media segment list element, or a BaseURL element.

For another example, the pointer may be carried by a ReferencedMediaPresentation element in the video adaptation set element VI. The ReferencedMediaPresentation element is a newly extended element. That is, the newly extended element in the video adaptation set element VI may be used to carry the pointer. A name of the newly extended element that carries the pointer and that is in the video adaptation set element VI is not limited to ReferencedMediaPresentation, and may be another element name.

Optionally, in some possible implementations of the present application, a timeline of the guide media presentation may be independent of a timeline of main media presentations to which the K guide units in the guide media presentation point. An audio of a guide unit may be obtained by encoding an audio of a main media presentation, and a video of the guide unit may be obtained by encoding a video of the main media presentation. Therefore, no correlation exists between a timeline of the guide unit and a timeline of the main media presentation.

It may be learned that, in the technical solution of this embodiment, each guide unit in K guide units may point to one main media presentation, and this is equivalent to a specific association relationship introduced between the guide unit and the main media presentation. Therefore, when a guide unit i in the K guide units is selected, a DASH client may obtain an MPD of a main media presentation j to which the guide unit i points, and may further obtain the main media presentation j according to the MPD of the main media presentation j and perform presenting. Evidently, this implements relatively flexible switching between a guide media presentation and a main media presentation, further supports a video guide in an HTTP-based media streaming service scenario, and further improves user experience.

In a guide service, videos of guide units are parallel, and videos of multiple guide units are presented on a display screen or in a window of user equipment. However, audios are exclusive. At any time, an audio of only one guide unit can be selected and played, and a focus of attention of a user exactly lies in a video picture of the guide unit. The guide service needs to be supported by a corresponding signaling mechanism. A client is notified, using signaling, of guide units included in a guide service, components of the guide units, a relationship between the guide units and member media presentations of the guide service, a relationship between video components of the guide units, a relationship between audio components of the guide units, and a relationship between the audio components and the video components of the guide units. Signaling of the guide service is represented by a description file of a guide media presentation and implemented by some elements in the description file, and represents various relationships between media representations of the media components.

The following provides multiple embodiments in which signaling of a guide service is implemented using different tools. The guide service in the examples serves 16 member media presentations. The MPD examples may be based on the following DASH specification and supplements and amendments thereof:

ISO/IEC 23009-1: Part 1: Media presentation description and segment formats, 2nd Edition, 2014.

ISO/IEC 23009-1:2014/FDAM 1.

Part 1: Media presentation description and segment formats.

AMENDMENT 1: High Profile and Availability Time Synchronization Extended profiles and time synchronization.

ISO/IEC 23009-1:2014/DAM 2.

Part 1: Media presentation description and segment formats.

AMENDMENT 2: Spatial Relationship Description, Generalized URL parameters and other extensions.

For convenience, each example is not a complete MPD, but is an MPD segment clipped for describing a related feature of the present application.

Example scenario 51: In the example scenario 51, an example of a signaling mechanism of a guide service is provided to notify a client of guide units included in the guide service, components of the guide units, a relationship between the guide units and member media presentations of the guide service, a relationship between video components of the guide units, a relationship between audio components of the guide units, and a relationship between the audio components and the video components of the guide units.

In this example, a Role element is used for each adaptation set element, including a video adaptation set element and an audio adaptation set element. In this way, adaptation set elements include Role elements, and adaptation sets in which parameters of the role descriptor elements are “main” are compatible and may be selected together by the client. For videos, media representations in multiple video adaptation sets, namely, video media representations of different guide units, may be selected together and presented on the client. For audios, only one audio media representation is selected, and corresponds to one guide unit.

A guide unit or a video of a guide unit and a main media presentation represented by the guide unit are represented by an attribute of a video adaptation set element of the guide unit, further, an attribute @xlink:href. The attribute is a pointer in essence, and the attribute is used to point to an MPD of a remote main media presentation. Because the element to which the attribute points is not an adaptation set element, the element to which the attribute points is not embedded in a guide MPD (a data model of an MPD is hierarchical, and an element includes only a lower-level element but does not include a higher-level element). This may be represented by @xlink:show.

In the existing DASH standard specification, an element to which @xlink:href points is consistent with a type of an element in which the attribute is located, that is, if the attribute is at an adaptation set element level, the element to which the attribute points is of an adaptation set element type. In the present application, the type of the element to which the attribute points is extended, and the attribute is used to point to a media presentation. Another difference from the existing specification lies in that, an adaptation set element not only includes a remote element (the attribute points to a remote element) but also includes a local media representation. This is not supported in the existing DASH specification.

In an audio media representation, an association relationship between the audio media presentation and a video media representation of a same guide unit is established using signaling. Further, a value of an identifier, namely, @id of the associated video media representation is referenced using an attribute @associationId. @associationType may not occur, and this indicates an unknown association relationship, or a definition of an association relationship such as “accompany” is added.

A semantic difference between elements of MPDs lies in a behavior of the client. The client selects multiple media representations that have a same role in the guide service. The role is described by Role elements in adaptation set elements to which the media representations belong. For example, parameters of the role descriptor elements are all main, and this indicates that the media representations in the adaptation sets are main components of a media presentation. The client selects multiple video media representations of multiple guide units, requests segments of the media representations from a content server, and after processing, presents the segments together to a user. Things such as a quantity of selected video adaptation sets (video media representations), a sequence in which the video adaptation sets are presented, a layout of presentation positions, and a presentation manner (moving picture sequence) may all be decided by the client. The decision may be made according to a user instruction, a configuration of the client by the user, a capability of the client, and the like.

When a focus of attention of the user hovers over a video picture of a guide unit, the client selects an audio media representation of the guide unit, obtains a segment of the audio media representation, and plays an audio.

When the user selects a video picture of a guide unit to watch a corresponding main media presentation, the client switches to the main media presentation. A switching process may include the following steps. The client first obtains an MPD of the main media presentation according to a pointer in the guide unit, then parses the MPD of the main media presentation, and selects an appropriate media representation, and finally adds the main media presentation at a time location, and this is actually a positioning operation (seeking). If the guide service is a live media presentation service, the time location is a time location of media content at which switching occurs, that is, a time location at which the guide service is interrupted.

The following provides a possible MPD example in the example scenario S1.

```
<?xml version=“1.0” encoding=“UTF-8”?>
<MPD
  xmlns:xsi=“http://www.w3.org/2001/XMLSchema-instance”
  xmlns=“urn:mpeg:dash:schema:mpd:2011”
  xsi:schemaLocation=“urn:mpeg:dash:schema:mpd:2011 DASH-MPD.xsd”
  [...]>
  <ProgramInformation>
    <Title>an Example of MPD for a media presentation with mosaic videos and their
audios </Title>
  </ProgramInformation>
  <Period>
      <!—Thumbnail video for presentation   1 -->
```

| | |
|---|---|
| <AdaptationSet | xlink:href=“http://example.com/main/p1.mpd” |

```
xlink:actuate=“onRequest” [...]>
        <Role schemeIdUri=“urn:mpeg:dash:role:2011” value=“main”/>
        <Representation id=“v1” bandwidth=“1000” width=“40” height=“40”>
            <SegmentTemplate
              media=“mosaic/$RepresentationID$_$Number%05d$.mp4”
              initialization=“mosaic/$RepresentationID$-init.mp4”
              duration=“4”/>
        </Representation>
    </AdaptationSet>
      ...
    <!—Thumbnail video for presentation 16   -->
```

| | |
|---|---|
| <AdaptationSet | xlink:href=“http://example.com/main/p1.mpd” |

```
xlink:actuate=“onRequest” [...]>
        <Role schemeIdUri=“urn:mpeg:dash:role:2011” value=“main”/>
        <Representation id=“v16” bandwidth=“1000” width=“40” height=“40”>
            <SegmentTemplate
              media=“mosaic/$RepresentationID$_$Number%05d$.mp4”
              initialization=“mosaic/$RepresentationID$-init.mp4”
              duration=“4”/>
        </Representation>
    </AdaptationSet>
    <!—audio accompanying each presentation   -->
    <AdaptationSet mimeType=“audio/mp4” codecs=“mp4a.40.2”>
        <Role schemeIdUri=“urn:mpeg:dash:role:2011” value=“main”/>
        <SegmentTemplate timescale=“48000” duration=“4”
          initialization=“mosaic/audio/en/init.mp4a”
          media=“mosia/audio/en/$RepresentationId$$Number$.mp4a”/>
        <!—audio for presentation   1 -->
          <Representation   id=“p1_a”   bandwidth=“64000”   associationId=“v1”
associationType=“dub”/>
        <!—audio for presentation   2 -->
          <Representation   id=“p2_a”   bandwidth=“64000”   associationId=“v2”
associationType=“dub”/>
                ......
        <!—audio for presentation   16 -->
          <Representation   id=“p16_a”   bandwidth=“64000”   associationId=“v16”
associationType=“dub”/>
    </AdaptationSet>
  </Period>
</MPD>
```

Example scenario S2: In the example scenario S2, an example of a signaling mechanism of a guide service is provided. The scenario S2 illustrates an MPD used for indicating composition of the guide service. In a guide description method, a uniform resource identifier is used as a parameter. The uniform resource identifier is used to point to a media presentation, and actually points to the media presentation by pointing to an MPD of the media presentation.

A method identifier, for example, urn:mpeg:dash:mosaic:2011, is defined for the method. If an @schemeId value of an EssentialProptery descriptor or a SupplementalProptery descriptor is the method identifier, it may indicate that an element including the descriptor: an adaptation set or a media representation is a component of the guide service. An attribute @value of the descriptor is a parameter of the guide service description method, namely, a uniform resource identifier pointing to an MPD of a main media presentation.

The following provides a possible MPD example in the example scenario S2.

```
<?xml version=“1.0” encoding=“UTF-8”?>
<MPD
  xmlns:xsi=“http://www.w3.org/2001/XMLSchema-instance”
  xmlns=“urn:mpeg:dash:schema:mpd:2011”
  xsi:schemaLocation=“urn:mpeg:dash:schema:mpd:2011 DASH-MPD.xsd”
  [...]>
  <ProgramInformation>
  <Title>an Example of MPD for a media presentation with mosaic videos and their audios
</Title>
  </ProgramInformation>
  <Period>
<BaseURL>mosaic\</BaseURL>
<SegmentTemplate
        media=“$RepresentationID$_$Number%05d$.mp4”
        initialization=“$RepresentationID$-init.mp4”
        duration=“4”/>
    <!—Thumbnail video for presentation   1 -->
    <AdaptationSet [...]>
```

| | | |
|---|---|---|
| <EssentialProperty | schemeIdUri=“urn:mpeg:dash:mosaic:2011” | value=“ |

```
http://example.com/main/p1.mpd”/>
        <Representation id=“v1” bandwidth=“1000” width=“40” height=“40” .../>
    </AdaptationSet>
      ......
    <!—Thumbnail video for presentation   16 -->
    <AdaptationSet [...]>
```

| | | |
|---|---|---|
| <EssentialProperty | schemeIdUri=“urn:mpeg:dash:mosaic:2011” | value=“ |

```
http://example.com/main/p16.mpd”/>
        <Representation id=“v16” bandwidth=“1000” width=“40” height=“40” .../>
    </AdaptationSet>
    <!—audio accompanying each presentation   -->
    <AdaptationSet mimeType=“audio/mp4” codecs=“mp4a.40.2”>
```

| | | |
|---|---|---|
| <EssentialProperty | schemeIdUri=“urn:mpeg:dash:mosaic:2011” | value=“ |

http://example.com/main/p1.mpd”/>

| | | |
|---|---|---|
| <SegmentTemplate | timescale=“48000” | duration=“4” |

initialization=“audio/en/init.mp4a”
media=“audio/en/$RepresentationId$$Number$.mp4a”/>
<!—audio for presentation 1 -->

| | | | |
|---|---|---|---|
| <Representation | id=“p1_a” | bandwidth=“64000” | associationId=“v1” |

associationType=“dub”/>
<!—audio for presentation 2 -->

| | | | |
|---|---|---|---|
| <Representation | id=“p1_a” | bandwidth=“64000” | associationId=“v2” |

```
associationType=“dub”/>
            ......
        <!—audio for presentation   16 -->
```

| | | | |
|---|---|---|---|
| <Representation | id=“p16_a” | bandwidth=“64000” | associationId=“v16” |

```
associationType=“dub”/>
    </AdaptationSet>
  </Period>
</MPD>
```

Example scenario S3: In the example scenario S3, one video adaptation set (corresponding to one guide unit) has two media representations. One is a virtual media representation. The virtual media representation does not include any media segment, but includes a pointer. The pointer points to a main media presentation represented by the guide unit, and actually points to the media presentation by pointing to an MPD of the media presentation. In this case, a segment template does not occur at an adaptation set element level, but occurs in an actual media representation element.

The following provides a possible MPD example in the example scenario S3.

```
<?xml version=“1.0” encoding=“UTF-8”?>
<MPD
  xmlns:xsi=“http://www.w3.org/2001/XMLSchema-instance”
  xmlns=“urn:mpeg:dash:schema:mpd:2011”
  xsi:schemaLocation=“urn:mpeg:dash:schema:mpd:2011 DASH-MPD.xsd”
  [...]>
  <ProgramInformation>
  <Title>an Example of MPD for a media presentation with mosaic videos and their audios
</Title>
  </ProgramInformation>
  <Period>
<!—Thumbnail video for presentation   1 -->
    <AdaptationSet [...]>
          <Role schemeIdUri=“urn:mpeg:dash:role:2011” value=“main”/>
          <Representation id=“v1” bandwidth=“1000” width=“40” height=“40”>
              <SegmentTemplate
                media=“mosaic/$RepresentationID$_$Number%05d$.mp4”
                initialization=“mosaic/$RepresentationID$-init.mp4”
                duration=“4”/>
          </Representation>
        <!-- pointing to the main presentation the thumbnail represents -->
```

| | |
|---|---|
| <Representation | xlink:href=“http://example.com/main/p1.mpd” |

```
xlink:actuate=“onRequest”/>
    </AdaptationSet>
      ......
    <!—Thumbnail video for presentation   16 -->
    <AdaptationSet [...]>
          <Role schemeIdUri=“urn:mpeg:dash:role:2011” value=“main”/>
          <Representation id=“v16” bandwidth=“1000” width=“40” height=“40”>
              <SegmentTemplate
                media=“mosaic/$RepresentationID$_$Number%05d$.mp4”
                initialization=“mosaic/$RepresentationID$-init.mp4”
                duration=“4”/>
          </Representation>
          <!-- pointing to the main presentation the thumbnail represents -->
```

| | |
|---|---|
| <Representation | xlink:href=“http://example.com/main/p16.mpd” |

```
xlink:actuate=“onRequest”/>
    </AdaptationSet>
    <!—audio accompanying each presentation   -->
    <AdaptationSet mimeType=“audio/mp4” codecs=“mp4a.40.2”>
          <Role schemeIdUri=“urn:mpeg:dash:role:2011” value=“main”/>
          <SegmentTemplate timescale=“48000” duration=“4”
            initialization=“main/audio/en/init.mp4a”
            media=“main/audio/en/$RepresentationId$$Number$.mp4a”/>
          <!—audio for presentation   1 -->
```

| | | | |
|---|---|---|---|
| <Representation | id=“p1_a” | bandwidth=“64000” | associationId=“v1” |

associationType=“dub”/>
<!—audio for presentation 2 -->

| | | | |
|---|---|---|---|
| <Representation | id=“p2_a” | bandwidth=“64000” | associationId=“v2” |

```
associationType=“dub”/>
                  ......
          <!—audio for presentation   16 -->
```

| | | | |
|---|---|---|---|
| <Representation | id=“p16_a” | bandwidth=“64000” | associationId=“v16” |

```
associationType=“dub”/>
    </AdaptationSet>
  </Period>
</MPD>
```

Example scenario S4: In the example scenario S4, it is considered that keeping strict compatibility with an MPD in the existing DASH may cause ambiguity and misunderstanding. For example, a type of a referenced remote unit may be learned only after the referenced remote unit is parsed, because a remote unit is only an XML object. The type of the referenced remote unit may be an MPD, or may be a time period or an adaptation set. If a compatibility restriction is loosened, a new element description is introduced into the MPD to indicate a referenced media representation, and this can avoid misunderstanding. The element may belong to parent elements at different levels, for example, an adaptation set or a media representation. A ReferencedMediaPresentation in an example of the example scenario S4 is a specific implementation.

The following provides a possible MPD example in the example scenario S4.

<?xml version=“1.0” encoding=“UTF-8”?>
<MPD
xmlns:xsi=“http://www.w3.org/2001/XMLSchema-instance”
xmlns=“urn:mpeg:dash:schema:mpd:2011”
xsi:schemaLocation=“urn:mpeg:dash:schema:mpd:2011 DASH-MPD.xsd”
[...]>
<ProgramInformation>
<Title>Example of a DASH Media Presentation Description using Spatial Relationships
Description to indicate a video mosaic service</Title>
</ProgramInformation>
<Period>
<!—Thumbnail video for presentation 1 -->
<AdaptationSet [...]>
<Role schemeIdUri=“urn:mpeg:dash:role:2011” value=“main”/>
<ReferencedMediaPresentation
xlink:href=“http://example.com/main/p1.mpd”
xlink:show=“new”
xlink:actuate=“onRequest/>
<Representation id=“v1” bandwidth=“1000” width=“40” height=“40”>
<SegmentTemplate
media=“mosaic/$RepresentationID$_$Number%05d$.mp4”
initialization=“mosaic/$RepresentationID$-init.mp4”
duration=“4”/>
</Representation>
</AdaptationSet>
......
<!—Thumbnail video for presentation 16 -->
<AdaptationSet xlink:href=“http://example.com/main/p1.mpd” xlink:actuate=“onRequest”
[...]>
<Role schemeIdUri=“urn:mpeg:dash:role:2011” value=“main”/>
<ReferencedMediaPresentation
xlink:href=“http://example.com/main/p1.mpd”
xlink:show=“new”
xlink:actuate=“onRequest/>
<Representation id=“v16” bandwidth=“1000” width=“40” height=“40”>
<SegmentTemplate
media=“mosaic/$RepresentationID$_$Number%05d$.mp4”
initialization=“mosaic/$RepresentationID$-init.mp4”
duration=“4”/>
</Representation>
</AdaptationSet>
<!—audio accompanying each presentation -->
<AdaptationSet mimeType=“audio/mp4” codecs=“mp4a.40.2”>
<Role schemeIdUri=“urn:mpeg:dash:role:2011” value=“main”/>
<SegmentTemplate timescale=“48000” duration=“4”
initialization=“main/audio/en/init.mp4a”
media=“main/audio/en/$RepresentationId$$Number$.mp4a”/>
<!—audio for presentation 1 -->

| <Representation | id=“p1_a” | bandwidth=“64000” | associationId=“v1” |
|---|---|---|---|
| associationType=“dub”/> | | | |
| <!—audio for presentation 2 --> | | | |
| <Representation | id=“p2_a” | bandwidth=“64000” | associationId=“v2” |
| associationType=“dub”/> | | | |
| ...... | | | |
| <!—audio for presentation 16 --> | | | |
| <Representation | id=“p16_a” | bandwidth=“64000” | associationId=“v16” |
| associationType=“dub”/> | | | |
| </AdaptationSet> | | | |
| </Period> | | | |
| </MPD> | | | |

Example scenario S5: In the example scenario S5, an example of an aggregate MPD is provided. The aggregate MPD is an MPD superset. The aggregate MPD describes multiple parallel media presentations, and includes member media presentations and a guide media presentation. A presentation element is introduced in the aggregate MPD. The presentation element may be a remote element, and points to an MPD, or may be an embedded MPD.

In the following example, an MPD of a member media presentation is a remote element, but an MPD of a guide media presentation is a local embedded MPD.

The following provides a possible MPD example in the example scenario S5.

```
<?xml version=“1.0” encoding=“UTF-8”?>
<NPD
    [...]>
  <Presentation @id=“p1” @xlink:href=“http://www.example.com/movie/MPD-1.mpd”/>
  <Presentation @id=“p2” @xlink:href=“http://www.example.com/movie/MPD-1.mpd”/>
      ......
  <Presentation @id=“p16” @xlink:href=“http://www.example.com/movie/MPD-1.mpd”/>
  <!-- Media Presentation with multiple thumbnail videos for Navigation -->
  <Presentation>
        <Period start=“PT0S” >
                <!-- Mosaic Video 1 -->
            <AdaptationSet id=“v1” @referencedMediaPresentation=“p1” >
                  <Representation id=“v11” width=“40” height=“30” bandwidth=“20000”/>
            </AdaptationSet>
                  <!-- Mosaic Video 2 -->
          <AdaptationSet id=“v2” @referencedMediaPresentation=“p2” >
                <Representation id=“v12” width=“40” height=“30” bandwidth=“20000”/>
          </AdaptationSet>
              ......
                      <!-- Mosaic Video 16 -->
          <AdaptationSet id=“16”>
              <Representation id=“v16” width=“40” height=“30” bandwidth=“20000”/>
          </AdaptationSet>
            <!-- AdaptationSet for Accompanied Audio of Representations   -->
      <AdaptationSet id=“21”>
            <Representation id=“a1” bandwidth=“8000” associationId=“v1”/>
            <Representation id=“a2” bandwidth=“8000” associationId=“v2”/>
                    ..........
            <Representation id=“a16” bandwidth=“8000” associationId=“v16”/>
        </AdaptationSet>
  </Period>
</Presentation>
</NPD>
```

It is understandable that, the foregoing MPD examples are merely illustrative. The technical solutions of the embodiments of the present application are not limited to the foregoing examples.

The embodiments of the present application further provide related apparatuses for implementing the foregoing solutions.

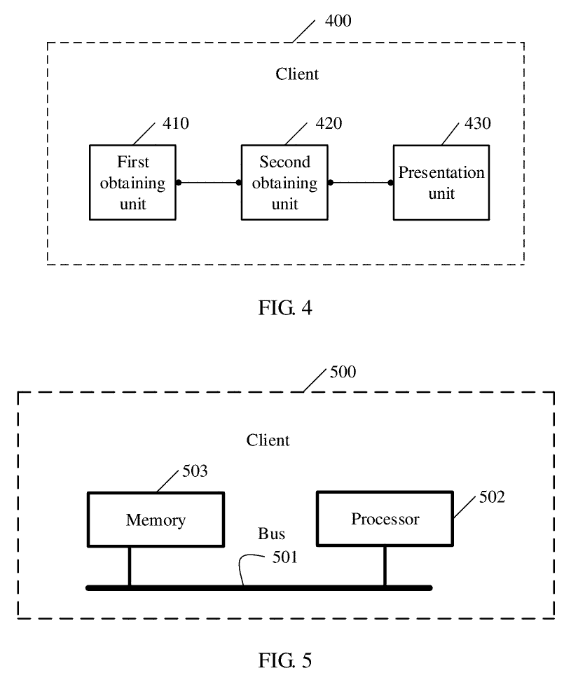

Referring to FIG. 4, an embodiment of the present application provides a client 400, which may include a first obtaining unit 410 configured to obtain an MPD of a guide media presentation, where the MPD of the guide media presentation describes N guide units included in the guide media presentation, and N is an integer greater than 1, a second obtaining unit 420 configured to obtain K guide units in the N guide units according to the MPD of the guide media presentation, and a presentation unit 430 configured to present the K guide units, where each guide unit in the K guide units points to one main media presentation, and presentation quality of a main media presentation to which a guide unit i in the K guide units points is higher than presentation quality of the guide unit i.

Optionally, in some possible implementations of the present application, the MPD of the guide media presentation may be different from an MPD of the main media presentation to which each guide unit in the K guide units points. That is, the guide media presentation may have an independent MPD, and the main media presentation to which each guide unit in the K guide units points may also have an independent MPD that is different from the MPD of the guide media presentation. For example, the K guide units point to K main media presentations, and the K main media presentations respectively have corresponding MPDs, namely, K MPDs, but the MPD of the guide media presentation is different from any one of the K MPDs, that is, the guide media presentation may be described by a (K+1)th MPD.

In addition, in other possible implementations of the present application, the MPD of the guide media presentation and an MPD of the main media presentation to which each guide unit in the K guide units points may be aggregated into one aggregate MPD (or referred to as a super MPD). That is, an aggregate MPD (or referred to as a super MPD) may be used to describe the guide media presentation and the main media presentation to which the guide media presentation points. Introduction of the super MPD enhances an association relationship between the guide media presentation and the main media presentation to which each guide unit points.

In an actual application, the guide unit may point to the main media presentation in a quite flexible manner. The guide unit may directly point to the main media presentation or may indirectly point to the main media presentation.

For example, each guide unit in the K guide units may point, by pointing to the MPD, to the main media presentation described by the MPD. Certainly, the guide unit may point to the main media presentation in another direct pointing or indirect pointing manner. For example, the MPD of the guide media presentation and the MPD of the main media presentation to which each guide unit in the K guide units points may be aggregated into one aggregate MPD. In this case, each guide unit in the K guide units may point to the main media presentation by referencing a presentation element in the aggregate MPD.

Optionally, in some possible implementations of the present application, each guide unit in the N guide units includes a video component, or each guide unit in the N guide units includes an audio component and a video component. Further, the guide unit may include a caption component or another type of media components.

The present application provides a guide service signaling mechanism using an MPD (such as an MPD in the DASH standard). The MPD may notify the client 400 of guide units included in a guide service, components of the guide units, a relationship between the guide units and member media presentations of the guide service, a relationship between video components of the guide units, a relationship between audio components of the guide units, a relationship between the audio components and the video components of the guide units, and the like.

Optionally, in some possible implementations of the present application, video components included in different guide units in the K guide units are media representations in different video adaptation sets in K video adaptation sets, selections are exclusive between media representations in any video adaptation set in the K video adaptation sets, and selections are compatible between different video adaptation sets in the K video adaptation sets. For example, a video component included in the guide unit i in the K guide units may belong to a video adaptation set Ci in the K video adaptation sets, and a video component included in a guide unit j in the K guide units may belong to a video adaptation set Cj in the K video adaptation sets. The video adaptation set Cj and the video adaptation set Ci are two different video adaptation sets in the K video adaptation sets. The guide unit j and the guide unit i may be any two guide units in the K guide units.

That selections are compatible means that the objects may be selected together. For example, if selections are compatible between different video adaptation sets in the K video adaptation sets, it indicates that media representations in multiple video adaptation sets in the K video adaptation sets may be selected together.

That selections are exclusive means that the objects cannot be selected together. For example, if selections are exclusive between media representations in any video adaptation set in the K video adaptation sets, it indicates that multiple media representations in one video adaptation set cannot be selected together. For example, assuming that a video adaptation set I in the K video adaptation sets includes 10 media representations, if selections are exclusive between the media representations in the video adaptation set, only one of the 10 media representations can be selected every time, and multiple media representations in the 10 media representations cannot be selected together.

Optionally, in some possible implementations of the present application, audio components included in the K guide units are media representations in an audio adaptation set, the audio adaptation set is different from any adaptation set in the K video adaptation sets, and selections are compatible between the audio adaptation set and the K video adaptation sets. For example, assuming that the audio adaptation set includes 20 media representations, if selections are exclusive between the media representations in the audio adaptation set, only one of the 20 media representations can be selected every time, and multiple media representations in the 20 media representations cannot be selected together.

Optionally, in other possible implementations of the present application, audio components included in different guide units in the K guide units are media representations in different audio adaptation sets in K audio adaptation sets, and selections are exclusive between different audio adaptation sets in the K audio adaptation sets.

Optionally, in some possible implementations of the present application, a media representation element in the audio adaptation set element may include a region description of a media representation, which is described by the media representation element, in an associated region in the guide media presentation.

Optionally, in some possible implementations of the present application, an association relationship exists between media representations described by media representation elements including a same region description, or an association relationship exists between adaptation sets described by adaptation set elements including a same region description. For example, a media representation described by a media representation element i is a media representation ri, and a media representation described by a media representation element j is a media representation rj, if the media representation element i and the media representation element j include a same region description, it may indicate that an association relationship exists between the media representation ri and the media representation rj.

Optionally, in some possible implementations of the present application, if the media representation element i and an adaptation set element ci include a same region description, it may also indicate that an association relationship exists between the media representation described by the media representation element i and each media representation in an adaptation set described by the adaptation set element ci. For example, the media representation described by the media representation element i may be an audio media representation, but the media representation in the adaptation set described by the adaptation set element ci may be a video media representation.

Optionally, in some possible implementations of the present application, the region description may be an SRD. Certainly, the region description may be another type of description information that may be used for describing a region of a guide unit in the guide media presentation.

Optionally, in some possible implementations of the present application, the MPD of the guide media presentation includes K video adaptation set elements, and the K video adaptation set elements correspond to the K video adaptation sets on a one-to-one basis.

The K video adaptation set elements include descriptor elements Ci, selections are compatible between video adaptation sets described by video adaptation set elements meeting a specified common condition in the K video adaptation set elements, and the specified common condition may be, for example, that descriptor elements Ci included in video adaptation set elements have same element names and schemeIdUri attributes.

Optionally, in some possible implementations of the present application, the descriptor element Ci may describe a case in which a media representation in a video adaptation set described by a video adaptation set element including the descriptor element Ci is a component of the guide media presentation. Alternatively, the descriptor element Ci may describe a role of a media representation, in a video adaptation set corresponding to a video adaptation set element including the descriptor element Ci, in the guide media presentation. For example, the role may be main, supplementary, caption, or dub of translation.

Optionally, in some possible implementations of the present application, the descriptor element Ci may be, for example, an EssentialProptery element or a SupplementalProptery element or a Role element or another element.

Optionally, in some possible implementations of the present application, if the descriptor element Ci is a Role element, the specified common condition may be that descriptor elements Ci included in video adaptation set elements may have same element names, schemeIdUri attributes, and parameter (value) attributes.

Optionally, in some possible implementations of the present application, the MPD of the guide media presentation includes the K video adaptation set elements, and the K video adaptation set elements correspond to the K video adaptation sets on a one-to-one basis. A video adaptation set element VI in the K video adaptation set elements that is corresponding to a video adaptation set I includes a pointer for pointing to a main media presentation, and the video adaptation set I may be any video adaptation set in the K video adaptation sets.

A position in which the pointer is carried in the video adaptation set element VI may be determined according to a requirement of a scenario.

For example, the pointer may be carried by an attribute of the video adaptation set element VI.

Further, for example, the pointer may be carried by an xlink:href attribute or another attribute of the video adaptation set element VI.

For another example, the pointer may be carried by an EssentialProptery element or a SupplementalProperty element in the video adaptation set element VI.

Further, for example, the pointer may be carried by a child element in an EssentialProptery element in the video adaptation set element VI, or the pointer may be carried by an attribute of an EssentialProptery element in the video adaptation set element VI, or the pointer may be carried by a child element in a SupplementalProperty element in the video adaptation set element VI, or the pointer may be carried by an attribute of a SupplementalProperty element in the video adaptation set element VI.

Further, for example, the pointer may be carried by a value attribute or another attribute of the EssentialProptery element in the video adaptation set element VI, or the pointer may be carried by a value attribute or another attribute of the SupplementalProperty element in the video adaptation set element VI.

For another example, the pointer may be carried by an attribute of a virtual Representation element in the video adaptation set element VI, or the pointer may be carried by a child element in a virtual Representation element in the video adaptation set element VI, where the virtual Representation element does not include a media segment template element, a media segment list element, or a BaseURL element.

For another example, the pointer may be carried by a ReferencedMediaPresentation element in the video adaptation set element VI. The ReferencedMediaPresentation element is a newly extended element. That is, the newly extended element in the video adaptation set element VI may be used to carry the pointer. A name of the newly extended element that carries the pointer and that is in the video adaptation set element VI is not limited to ReferencedMediaPresentation, and may be another element name.

Optionally, in some possible implementations of the present application, a timeline of the guide media presentation may be independent of a timeline of main media presentations to which the K guide units in the guide media presentation point. An audio of a guide unit may be obtained by encoding an audio of a main media presentation, and a video of the guide unit may be obtained by encoding a video of the main media presentation. Therefore, no correlation exists between a timeline of the guide unit and a timeline of the main media presentation.

Optionally, in some possible implementations of the present application, the presentation unit is further configured to present an audio component of the guide unit i when a focus of attention hovers over the guide unit i in the K guide units.

Optionally, in some possible implementations of the present application, the presentation unit is further configured to obtain, when the guide unit i in the K guide units is selected, the main media presentation to which the guide unit i points. Further, the client 400 may present the main media presentation to which the guide unit i points.

For example, the client 400 may be a personal computer, a mobile phone, a tablet computer, a television set, or a set top box.

It is understandable that, functions of each functional module of the client 400 in this embodiment may be further implemented according to the method in the foregoing method embodiment. For a specific implementation process thereof, refer to the related description in the foregoing method embodiment. Details are not described herein again. The client 400 may be configured to implement any method for providing a media presentation guide in media streaming over the HTTP provided in the foregoing embodiments.

It may be learned that, in the technical solution of this embodiment, each guide unit in K guide units may point to one main media presentation, and this is equivalent to a specific association relationship introduced between the guide unit and the main media presentation. Therefore, when a guide unit i in the K guide units is selected, the client 400 may obtain an MPD of a main media presentation j to which the guide unit i points, and may further obtain the main media presentation j according to the MPD of the main media presentation j and perform presenting. Evidently, this implements relatively flexible switching between a guide media presentation and a main media presentation, further supports a video guide in an HTTP-based media streaming service scenario, and further improves user experience.

Referring to FIG. 5, an embodiment of the present application provides a client 500, which may include a processor 502 and a memory 503. The processor 502 and the memory 503 are coupled and connected using a bus 501.

By invoking code or an instruction in the memory 503, the processor 502 is configured to obtain an MPD of a guide media presentation, where the MPD of the guide media presentation describes N guide units included in the guide media presentation, and N is an integer greater than 1, obtain K guide units in the N guide units according to the MPD of the guide media presentation, and present the K guide units, where each guide unit in the K guide units points to one main media presentation, and presentation quality of a main media presentation to which a guide unit i in the K guide units points is higher than presentation quality of the guide unit i.

Optionally, in some possible implementations of the present application, the MPD of the guide media presentation may be different from an MPD of the main media presentation to which each guide unit in the K guide units points. That is, the guide media presentation may have an independent MPD, and the main media presentation to which each guide unit in the K guide units points may also have an independent MPD that is different from the MPD of the guide media presentation. For example, the K guide units point to K main media presentations, and the K main media presentations respectively have corresponding MPDs, namely, K MPDs, but the MPD of the guide media presentation is different from any one of the K MPDs, that is, the guide media presentation may be described by a (K+1)th MPD.

In addition, in other possible implementations of the present application, the MPD of the guide media presentation and an MPD of the main media presentation to which each guide unit in the K guide units points may be aggregated into one aggregate MPD (or referred to as a super MPD). That is, an aggregate MPD (or referred to as a super MPD) may be used to describe the guide media presentation and the main media presentation to which the guide media presentation points. Introduction of the super MPD enhances an association relationship between the guide media presentation and the main media presentation to which each guide unit points.

In an actual application, the guide unit may point to the main media presentation in a quite flexible manner. The guide unit may directly point to the main media presentation or may indirectly point to the main media presentation.

For example, each guide unit in the K guide units may point, by pointing to the MPD, to the main media presentation described by the MPD. Certainly, the guide unit may point to the main media presentation in another direct pointing or indirect pointing manner. For example, the MPD of the guide media presentation and the MPD of the main media presentation to which each guide unit in the K guide units points may be aggregated into one aggregate MPD. In this case, each guide unit in the K guide units may point to the main media presentation by referencing a presentation element in the aggregate MPD.

Optionally, in some possible implementations of the present application, each guide unit in the N guide units includes a video component, or each guide unit in the N guide units includes an audio component and a video component. Further, the guide unit may include a caption component or another type of media components.

The present application provides a guide service signaling mechanism using an MPD (such as an MPD in the DASH standard). The MPD may notify the client 500 of guide units included in a guide service, components of the guide units, a relationship between the guide units and member media presentations of the guide service, a relationship between video components of the guide units, a relationship between audio components of the guide units, a relationship between the audio components and the video components of the guide units, and the like.

Optionally, in some possible implementations of the present application, video components included in different guide units in the K guide units are media representations in different video adaptation sets in K video adaptation sets, selections are exclusive between media representations in any video adaptation set in the K video adaptation sets, and selections are compatible between different video adaptation sets in the K video adaptation sets. For example, a video component included in the guide unit i in the K guide units may belong to a video adaptation set Ci in the K video adaptation sets, and a video component included in a guide unit j in the K guide units may belong to a video adaptation set Cj in the K video adaptation sets. The video adaptation set Cj and the video adaptation set Ci are two different video adaptation sets in the K video adaptation sets. The guide unit j and the guide unit i may be any two guide units in the K guide units.

That selections are compatible means that the objects may be selected together. For example, if selections are compatible between different video adaptation sets in the K video adaptation sets, it indicates that media representations in multiple video adaptation sets in the K video adaptation sets may be selected together.

That selections are exclusive means that the objects cannot be selected together. For example, if selections are exclusive between media representations in any video adaptation set in the K video adaptation sets, it indicates that multiple media representations in one video adaptation set cannot be selected together. For example, assuming that a video adaptation set I in the K video adaptation sets includes 10 media representations, if selections are exclusive between the media representations in the video adaptation set, only one of the 10 media representations can be selected every time, and multiple media representations in the 10 media representations cannot be selected together.

Optionally, in some possible implementations of the present application, audio components included in the K guide units are media representations in an audio adaptation set, the audio adaptation set is different from any adaptation set in the K video adaptation sets, and selections are compatible between the audio adaptation set and the K video adaptation sets. For example, assuming that the audio adaptation set includes 20 media representations, if selections are exclusive between the media representations in the audio adaptation set, only one of the 20 media representations can be selected every time, and multiple media representations in the 20 media representations cannot be selected together.

Optionally, in other possible implementations of the present application, audio components included in different guide units in the K guide units are media representations in different audio adaptation sets in K audio adaptation sets, and selections are exclusive between different audio adaptation sets in the K audio adaptation sets.

Optionally, in some possible implementations of the present application, a media representation element in the audio adaptation set element may include a region description of a media representation, which is described by the media representation element, in an associated region in the guide media presentation.

Optionally, in some possible implementations of the present application, an association relationship exists between media representations described by media representation elements including a same region description, or an association relationship exists between adaptation sets described by adaptation set elements including a same region description. For example, a media representation described by a media representation element i is a media representation ri, and a media representation described by a media representation element j is a media representation rj, and if the media representation element i and the media representation element j include a same region description, it may indicate that an association relationship exists between the media representation ri and the media representation rj.

Optionally, in some possible implementations of the present application, if the media representation element i and an adaptation set element ci include a same region description, it may also indicate that an association relationship exists between the media representation described by the media representation element i and each media representation in an adaptation set described by the adaptation set element ci. For example, the media representation described by the media representation element i may be an audio media representation, but the media representation in the adaptation set described by the adaptation set element ci may be a video media representation.

Optionally, in some possible implementations of the present application, the region description may be an SRD. Certainly, the region description may be another type of description information that may be used for describing a region of a guide unit in the guide media presentation.

Optionally, in some possible implementations of the present application, the MPD of the guide media presentation includes K video adaptation set elements, and the K video adaptation set elements correspond to the K video adaptation sets on a one-to-one basis.

The K video adaptation set elements include descriptor elements Ci, selections are compatible between video adaptation sets described by video adaptation set elements meeting a specified common condition in the K video adaptation set elements, and the specified common condition may be, for example, that descriptor elements Ci included in video adaptation set elements have same element names and schemeIdUri attributes.

Optionally, in some possible implementations of the present application, the descriptor element Ci may describe a case in which a media representation in a video adaptation set described by a video adaptation set element including the descriptor element Ci is a component of the guide media presentation. Alternatively, the descriptor element Ci may describe a role of a media representation, in a video adaptation set corresponding to a video adaptation set element including the descriptor element Ci, in the guide media presentation. For example, the role may be main, supplementary, caption, or dub of translation.

Optionally, in some possible implementations of the present application, the descriptor element Ci may be, for example, an EssentialProptery element or a SupplementalProptery element or a Role element or another element.

Optionally, in some possible implementations of the present application, if the descriptor element Ci is a Role element, the specified common condition may be that descriptor elements Ci included in video adaptation set elements may have same element names, schemeIdUri attributes, and parameter (value) attributes.

Optionally, in some possible implementations of the present application, the MPD of the guide media presentation includes the K video adaptation set elements, and the K video adaptation set elements correspond to the K video adaptation sets on a one-to-one basis. A video adaptation set element VI in the K video adaptation set elements that is corresponding to a video adaptation set I includes a pointer for pointing to a main media presentation, and the video adaptation set I may be any video adaptation set in the K video adaptation sets.

A position in which the pointer is carried in the video adaptation set element VI may be determined according to a requirement of a scenario.

For example, the pointer may be carried by an attribute of the video adaptation set element VI.

Further, for example, the pointer may be carried by an xlink:href attribute or another attribute of the video adaptation set element VI.

For another example, the pointer may be carried by an EssentialProptery element or a SupplementalProperty element in the video adaptation set element VI.

Further, for example, the pointer may be carried by a child element in an EssentialProptery element in the video adaptation set element VI, or the pointer may be carried by an attribute of an EssentialProptery element in the video adaptation set element VI, or the pointer may be carried by a child element in a SupplementalProperty element in the video adaptation set element VI, or the pointer may be carried by an attribute of a SupplementalProperty element in the video adaptation set element VI.

Further, for example, the pointer may be carried by a value attribute or another attribute of the EssentialProptery element in the video adaptation set element VI, or the pointer may be carried by a value attribute or another attribute of the SupplementalProperty element in the video adaptation set element VI.

For another example, the pointer may be carried by an attribute of a virtual Representation element in the video adaptation set element VI, or the pointer may be carried by a child element in a virtual Representation element in the video adaptation set element VI, where the virtual Representation element does not include a media segment template element, a media segment list element, or a BaseURL element.

For another example, the pointer may be carried by a ReferencedMediaPresentation element in the video adaptation set element VI. The ReferencedMediaPresentation element is a newly extended element. That is, the newly extended element in the video adaptation set element VI may be used to carry the pointer. A name of the newly extended element that carries the pointer and that is in the video adaptation set element VI is not limited to ReferencedMediaPresentation, and may be another element name.

Optionally, in some possible implementations of the present application, a timeline of the guide media presentation may be independent of a timeline of main media presentations to which the K guide units in the guide media presentation point. An audio of a guide unit may be obtained by encoding an audio of a main media presentation, and a video of the guide unit may be obtained by encoding a video of the main media presentation. Therefore, no correlation exists between a timeline of the guide unit and a timeline of the main media presentation.

Optionally, in some possible implementations of the present application, the processor 502 is further configured to present an audio component of the guide unit i when a focus of attention hovers over the guide unit i in the K guide units.

Optionally, in some possible implementations of the present application, the processor 502 is further configured to obtain, when the guide unit i in the K guide units is selected, the main media presentation to which the guide unit i points. Further, the client 500 may present the main media presentation to which the guide unit i points.

For example, the client 500 may be a personal computer, a mobile phone, a tablet computer, a television set, or a set top box.

It is understandable that, functions of the client 500 in this embodiment may be further implemented according to the method in the foregoing method embodiment. For a specific implementation process thereof, refer to the related description in the foregoing method embodiment. Details are not described herein again. The client 500 may be configured to implement any method for providing a media presentation guide in media streaming over the HTTP provided in the foregoing embodiments.

It may be learned that, in the technical solution of this embodiment, each guide unit in K guide units may point to one main media presentation, and this is equivalent to a specific association relationship introduced between the guide unit and the main media presentation. Therefore, when a guide unit i in the K guide units is selected, the client 500 may obtain an MPD of a main media presentation j to which the guide unit i points, and may further obtain the main media presentation j according to the MPD of the main media presentation j and perform presenting. Evidently, this implements relatively flexible switching between a guide media presentation and a main media presentation, further supports a video guide in an HTTP-based media streaming service scenario, and further improves user experience.

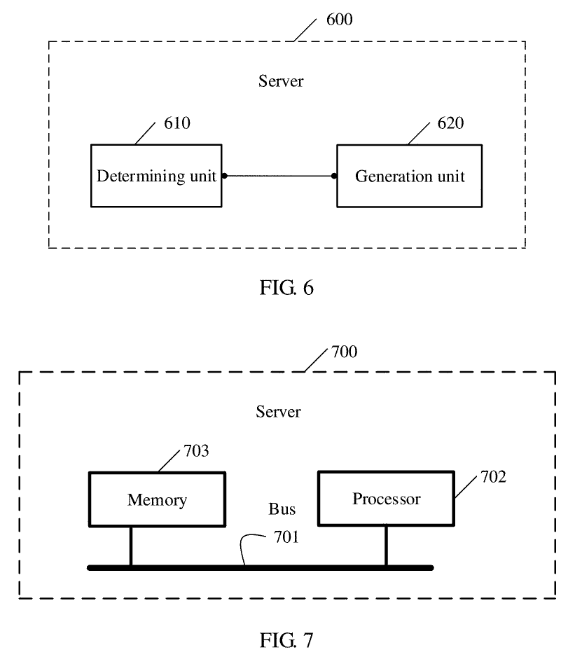

Referring to FIG. 6, an embodiment of the present application provides a server 600, which may include a determining unit 610 configured to determine N guide units included in a guide media presentation, and a generation unit 620 configured to generate an MPD of the guide media presentation, where the MPD of the guide media presentation describes the N guide units included in the guide media presentation, N is an integer greater than 1, each guide unit in the N guide units points to one main media presentation, and presentation quality of a main media presentation to which a guide unit i in the N guide units points is higher than presentation quality of the guide unit i.

The presentation quality of the main media presentation to which the guide unit i in the N guide units points is higher than the presentation quality of the guide unit i. That is, presentation quality of a media representation of a guide unit is lower than presentation quality of a main media presentation represented by the guide unit.

Optionally, in some possible implementations of the present application, the MPD of the guide media presentation may be different from an MPD of the main media presentation to which each guide unit in the N guide units points. That is, the guide media presentation may have an independent MPD, and the main media presentation to which each guide unit in the N guide units points may also have an independent MPD that is different from the MPD of the guide media presentation. For example, the N guide units point to N main media presentations, and the N main media presentations respectively have corresponding MPDs, namely, N MPDs, but the MPD of the guide media presentation is different from any one of the N MPDs, that is, the guide media presentation may be described by an (N+1)th MPD.

In addition, in other possible implementations of the present application, the MPD of the guide media presentation and an MPD of the main media presentation to which each guide unit in the N guide units points may be aggregated into one aggregate MPD (or referred to as a super MPD). That is, an aggregate MPD (or referred to as a super MPD) may be used to describe the guide media presentation and the main media presentation to which the guide media presentation points. Introduction of the super MPD enhances an association relationship between the guide media presentation and the main media presentation to which each guide unit points.

In an actual application, the guide unit may point to the main media presentation in a quite flexible manner. The guide unit may directly point to the main media presentation or may indirectly point to the main media presentation.

For example, each guide unit in the N guide units may point, by pointing to the MPD, to the main media presentation described by the MPD. Certainly, the guide unit may point to the main media presentation in another direct pointing or indirect pointing manner. For example, the MPD of the guide media presentation and the MPD of the main media presentation to which each guide unit in the N guide units points may be aggregated into one aggregate MPD. In this case, each guide unit in the N guide units may point to the main media presentation by referencing a presentation element in the aggregate MPD.

Optionally, in some possible implementations of the present application, each guide unit in the N guide units includes a video component, or each guide unit in the N guide units includes an audio component and a video component. Further, the guide unit may include a caption component or another type of media components.

The present application provides a guide service signaling mechanism using an MPD (such as an MPD in the DASH standard). The MPD may notify a client of guide units included in a guide service, components of the guide units, a relationship between the guide units and member media presentations of the guide service, a relationship between video components of the guide units, a relationship between audio components of the guide units, a relationship between the audio components and the video components of the guide units, and the like.

Optionally, in some possible implementations of the present application, video components included in different guide units in the N guide units are media representations in different video adaptation sets in N video adaptation sets, selections are exclusive between media representations in any video adaptation set in the N video adaptation sets, and selections are compatible between different video adaptation sets in the N video adaptation sets. For example, a video component included in the guide unit i in the N guide units may belong to a video adaptation set Ci in the N video adaptation sets, and a video component included in a guide unit j in the N guide units may belong to a video adaptation set Cj in the N video adaptation sets. The video adaptation set Cj and the video adaptation set Ci are two different video adaptation sets in the N video adaptation sets. The guide unit j and the guide unit i may be any two guide units in the N guide units.

That selections are compatible means that the objects may be selected together. For example, if selections are compatible between different video adaptation sets in the N video adaptation sets, it indicates that media representations in multiple video adaptation sets in the N video adaptation sets may be selected together.

That selections are exclusive means that the objects cannot be selected together. For example, if selections are exclusive between media representations in any video adaptation set in the N video adaptation sets, it indicates that multiple media representations in one video adaptation set cannot be selected together. For example, assuming that a video adaptation set I in the N video adaptation sets includes 10 media representations, if selections are exclusive between the media representations in the video adaptation set, only one of the 10 media representations can be selected every time, and multiple media representations in the 10 media representations cannot be selected together.

Optionally, in some possible implementations of the present application, audio components included in the N guide units are media representations in an audio adaptation set, the audio adaptation set is different from any adaptation set in the N video adaptation sets, and selections are compatible between the audio adaptation set and the N video adaptation sets. For example, assuming that the audio adaptation set includes 20 media representations, if selections are exclusive between the media representations in the audio adaptation set, only one of the 20 media representations can be selected every time, and multiple media representations in the 20 media representations cannot be selected together.

Optionally, in other possible implementations of the present application, audio components included in different guide units in the N guide units are media representations in different audio adaptation sets in N audio adaptation sets, and selections are exclusive between different audio adaptation sets in the N audio adaptation sets.

Optionally, in some possible implementations of the present application, a media representation element in the audio adaptation set element may include a region description of a media representation, which is described by the media representation element, in an associated region in the guide media presentation.

Optionally, in some possible implementations of the present application, an association relationship exists between media representations described by media representation elements including a same region description, or an association relationship exists between adaptation sets described by adaptation set elements including a same region description. For example, a media representation described by a media representation element i is a media representation ri, and a media representation described by a media representation element j is a media representation rj, and if the media representation element i and the media representation element j include a same region description, it may indicate that an association relationship exists between the media representation ri and the media representation rj.

Optionally, in some possible implementations of the present application, if the media representation element i and an adaptation set element ci include a same region description, it may also indicate that an association relationship exists between the media representation described by the media representation element i and each media representation in an adaptation set described by the adaptation set element ci. For example, the media representation described by the media representation element i may be an audio media representation, but the media representation in the adaptation set described by the adaptation set element ci may be a video media representation.

Optionally, in some possible implementations of the present application, the region description may be an SRD. Certainly, the region description may be another type of description information that may be used for describing a region of a guide unit in the guide media presentation.

Optionally, in some possible implementations of the present application, the MPD of the guide media presentation includes N video adaptation set elements, and the N video adaptation set elements correspond to the N video adaptation sets on a one-to-one basis.

The N video adaptation set elements include descriptor elements Ci, selections are compatible between video adaptation sets described by video adaptation set elements meeting a specified common condition in the N video adaptation set elements, and the specified common condition may be, for example, that descriptor elements Ci included in video adaptation set elements have same element names and schemeIdUri attributes.

Optionally, in some possible implementations of the present application, the descriptor element Ci may describe a case in which a media representation in a video adaptation set described by a video adaptation set element including the descriptor element Ci is a component of the guide media presentation. Alternatively, the descriptor element Ci may describe a role of a media representation, in a video adaptation set corresponding to a video adaptation set element including the descriptor element Ci, in the guide media presentation. For example, the role may be main, supplementary, caption, or dub of translation.

Optionally, in some possible implementations of the present application, the descriptor element Ci may be, for example, an EssentialProptery element or a SupplementalProptery element or a Role element or another element.

Optionally, in some possible implementations of the present application, if the descriptor element Ci is a Role element, the specified common condition may be that descriptor elements Ci included in video adaptation set elements may have same element names, schemeIdUri attributes, and parameter (value) attributes.

Optionally, in some possible implementations of the present application, the MPD of the guide media presentation includes the N video adaptation set elements, and the N video adaptation set elements correspond to the N video adaptation sets on a one-to-one basis. A video adaptation set element VI in the N video adaptation set elements that is corresponding to a video adaptation set I includes a pointer for pointing to a main media presentation, and the video adaptation set I may be any video adaptation set in the N video adaptation sets.

A position in which the pointer is carried in the video adaptation set element VI may be determined according to a requirement of a scenario.

For example, the pointer may be carried by an attribute of the video adaptation set element VI.

Further, for example, the pointer may be carried by an xlink:href attribute or another attribute of the video adaptation set element VI.

For another example, the pointer may be carried by an EssentialProptery element or a SupplementalProperty element in the video adaptation set element VI.

Further, for example, the pointer may be carried by a child element in an EssentialProptery element in the video adaptation set element VI, or the pointer may be carried by an attribute of an EssentialProptery element in the video adaptation set element VI, or the pointer may be carried by a child element in a SupplementalProperty element in the video adaptation set element VI, or the pointer may be carried by an attribute of a SupplementalProperty element in the video adaptation set element VI.

Further, for example, the pointer may be carried by a value attribute or another attribute of the EssentialProptery element in the video adaptation set element VI, or the pointer may be carried by a value attribute or another attribute of the SupplementalProperty element in the video adaptation set element VI.

For another example, the pointer may be carried by an attribute of a virtual Representation element in the video adaptation set element VI, or the pointer may be carried by a child element in a virtual Representation element in the video adaptation set element VI, where the virtual Representation element does not include a media segment template element, a media segment list element, or a BaseURL element.

For another example, the pointer may be carried by a ReferencedMediaPresentation element in the video adaptation set element VI. The ReferencedMediaPresentation element is a newly extended element. That is, the newly extended element in the video adaptation set element VI may be used to carry the pointer. A name of the newly extended element that carries the pointer and that is in the video adaptation set element VI is not limited to ReferencedMediaPresentation, and may be another element name.

Optionally, in some possible implementations of the present application, a timeline of the guide media presentation may be independent of a timeline of main media presentations to which the N guide units in the guide media presentation point. An audio of a guide unit may be obtained by encoding an audio of a main media presentation, and a video of the guide unit may be obtained by encoding a video of the main media presentation. Therefore, no correlation exists between a timeline of the guide unit and a timeline of the main media presentation.

It is understandable that, functions of each functional module of the server 600 in this embodiment may be further implemented according to the method in the foregoing method embodiment. For a specific implementation process thereof, refer to the related description in the foregoing method embodiment. Details are not described herein again. The server 600 may be configured to implement any method for providing a media presentation guide in media streaming over the HTTP provided in the foregoing embodiments.

The server 600 may be a content server or another server.

It may be learned that, in the technical solution of this embodiment, an MPD that is of a guide media presentation and is generated by the server 600 describes N guide units included in the guide media presentation. Each guide unit in the N guide units may point to one main media presentation, and this is equivalent to a specific association relationship introduced between the guide unit and the main media presentation. Therefore, when a guide unit i in the N guide units is selected on a client, the client may obtain an MPD of a main media presentation j to which the guide unit i points, and may further obtain the main media presentation j according to the MPD of the main media presentation j and perform presenting. Evidently, this solution lays a basis for implementing relatively flexible switching between the guide media presentation and the main media presentation, and further lays a basis for supporting a video guide in an HTTP-based media streaming service scenario.

Referring to FIG. 7, an embodiment of the present application provides a server 700, which may include a processor 702 and a memory 703. The processor 702 and the memory 703 are coupled and connected using a bus 701.

By invoking code or an instruction in the memory 703, the processor 702 is configured to determine N guide units included in a guide media presentation, and generate an MPD of the guide media presentation, where the MPD of the guide media presentation describes the N guide units included in the guide media presentation, N is an integer greater than 1, each guide unit in the N guide units points to one main media presentation, and presentation quality of a main media presentation to which a guide unit i in the N guide units points is higher than presentation quality of the guide unit i.

The presentation quality of the main media presentation to which the guide unit i in the N guide units points is higher than the presentation quality of the guide unit i. That is, presentation quality of a media representation of a guide unit is lower than presentation quality of a main media presentation represented by the guide unit.

Optionally, in some possible implementations of the present application, the MPD of the guide media presentation may be different from an MPD of the main media presentation to which each guide unit in the N guide units points. That is, the guide media presentation may have an independent MPD, and the main media presentation to which each guide unit in the N guide units points may also have an independent MPD that is different from the MPD of the guide media presentation. For example, the N guide units point to N main media presentations, and the N main media presentations respectively have corresponding MPDs, namely, N MPDs, but the MPD of the guide media presentation is different from any one of the N MPDs, that is, the guide media presentation may be described by an (N+1)th MPD.

In addition, in other possible implementations of the present application, the MPD of the guide media presentation and an MPD of the main media presentation to which each guide unit in the N guide units points may be aggregated into one aggregate MPD (or referred to as a super MPD). That is, an aggregate MPD (or referred to as a super MPD) may be used to describe the guide media presentation and the main media presentation to which the guide media presentation points. Introduction of the super MPD enhances an association relationship between the guide media presentation and the main media presentation to which each guide unit points.

In an actual application, the guide unit may point to the main media presentation in a quite flexible manner. The guide unit may directly point to the main media presentation or may indirectly point to the main media presentation.

For example, each guide unit in the N guide units may point, by pointing to the MPD, to the main media presentation described by the MPD. Certainly, the guide unit may point to the main media presentation in another direct pointing or indirect pointing manner. For example, the MPD of the guide media presentation and the MPD of the main media presentation to which each guide unit in the N guide units points may be aggregated into one aggregate MPD. In this case, each guide unit in the N guide units may point to the main media presentation by referencing a presentation element in the aggregate MPD.

Optionally, in some possible implementations of the present application, each guide unit in the N guide units includes a video component, or each guide unit in the N guide units includes an audio component and a video component. Further, the guide unit may include a caption component or another type of media components.

The present application provides a guide service signaling mechanism using an MPD (such as an MPD in the DASH standard). The MPD may notify a client of guide units included in a guide service, components of the guide units, a relationship between the guide units and member media presentations of the guide service, a relationship between video components of the guide units, a relationship between audio components of the guide units, a relationship between the audio components and the video components of the guide units, and the like.

Optionally, in some possible implementations of the present application, video components included in different guide units in the N guide units are media representations in different video adaptation sets in N video adaptation sets, selections are exclusive between media representations in any video adaptation set in the N video adaptation sets, and selections are compatible between different video adaptation sets in the N video adaptation sets. For example, a video component included in the guide unit i in the N guide units may belong to a video adaptation set Ci in the N video adaptation sets, and a video component included in a guide unit j in the N guide units may belong to a video adaptation set Cj in the N video adaptation sets. The video adaptation set Cj and the video adaptation set Ci are two different video adaptation sets in the N video adaptation sets. The guide unit j and the guide unit i may be any two guide units in the N guide units.

That selections are compatible means that the objects may be selected together. For example, if selections are compatible between different video adaptation sets in the N video adaptation sets, it indicates that media representations in multiple video adaptation sets in the N video adaptation sets may be selected together.

That selections are exclusive means that the objects cannot be selected together. For example, if selections are exclusive between media representations in any video adaptation set in the N video adaptation sets, it indicates that multiple media representations in one video adaptation set cannot be selected together. For example, assuming that a video adaptation set I in the N video adaptation sets includes 10 media representations, if selections are exclusive between the media representations in the video adaptation set, only one of the 10 media representations can be selected every time, and multiple media representations in the 10 media representations cannot be selected together.

Optionally, in some possible implementations of the present application, audio components included in the N guide units are media representations in an audio adaptation set, the audio adaptation set is different from any adaptation set in the N video adaptation sets, and selections are compatible between the audio adaptation set and the N video adaptation sets. For example, assuming that the audio adaptation set includes 20 media representations, if selections are exclusive between the media representations in the audio adaptation set, only one of the 20 media representations can be selected every time, and multiple media representations in the 20 media representations cannot be selected together.

Optionally, in other possible implementations of the present application, audio components included in different guide units in the N guide units are media representations in different audio adaptation sets in N audio adaptation sets, and selections are exclusive between different audio adaptation sets in the N audio adaptation sets.

Optionally, in some possible implementations of the present application, a media representation element in the audio adaptation set element may include a region description of a media representation, which is described by the media representation element, in an associated region in the guide media presentation.

Optionally, in some possible implementations of the present application, an association relationship exists between media representations described by media representation elements including a same region description, or an association relationship exists between adaptation sets described by adaptation set elements including a same region description. For example, a media representation described by a media representation element i is a media representation ri, and a media representation described by a media representation element j is a media representation rj, and if the media representation element i and the media representation element j include a same region description, it may indicate that an association relationship exists between the media representation ri and the media representation rj.

Optionally, in some possible implementations of the present application, if the media representation element i and an adaptation set element ci include a same region description, it may also indicate that an association relationship exists between the media representation described by the media representation element i and each media representation in an adaptation set described by the adaptation set element ci. For example, the media representation described by the media representation element i may be an audio media representation, but the media representation in the adaptation set described by the adaptation set element ci may be a video media representation.

Optionally, in some possible implementations of the present application, the region description may be an SRD. Certainly, the region description may be another type of description information that may be used for describing a region of a guide unit in the guide media presentation.

Optionally, in some possible implementations of the present application, the MPD of the guide media presentation includes N video adaptation set elements, and the N video adaptation set elements correspond to the N video adaptation sets on a one-to-one basis.

The N video adaptation set elements include descriptor elements Ci, selections are compatible between video adaptation sets described by video adaptation set elements meeting a specified common condition in the N video adaptation set elements, and the specified common condition may be, for example, that descriptor elements Ci included in video adaptation set elements have same element names and schemeIdUri attributes.

Optionally, in some possible implementations of the present application, the descriptor element Ci may describe a case in which a media representation in a video adaptation set described by a video adaptation set element including the descriptor element Ci is a component of the guide media presentation. Alternatively, the descriptor element Ci may describe a role of a media representation, in a video adaptation set corresponding to a video adaptation set element including the descriptor element Ci, in the guide media presentation. For example, the role may be main, supplementary, caption, or dub of translation.

Optionally, in some possible implementations of the present application, the descriptor element Ci may be, for example, an EssentialProptery element or a SupplementalProptery element or a Role element or another element.

Optionally, in some possible implementations of the present application, if the descriptor element Ci is a Role element, the specified common condition may be that descriptor elements Ci included in video adaptation set elements may have same element names, schemeIdUri attributes, and parameter (value) attributes.

Optionally, in some possible implementations of the present application, the MPD of the guide media presentation includes the N video adaptation set elements, and the N video adaptation set elements correspond to the N video adaptation sets on a one-to-one basis. A video adaptation set element VI in the N video adaptation set elements that is corresponding to a video adaptation set I includes a pointer for pointing to a main media presentation, and the video adaptation set I may be any video adaptation set in the N video adaptation sets.

A position in which the pointer is carried in the video adaptation set element VI may be determined according to a requirement of a scenario.

For example, the pointer may be carried by an attribute of the video adaptation set element VI.

Further, for example, the pointer may be carried by an xlink:href attribute or another attribute of the video adaptation set element VI.

For another example, the pointer may be carried by an EssentialProptery element or a SupplementalProperty element in the video adaptation set element VI.

Further, for example, the pointer may be carried by a child element in an EssentialProptery element in the video adaptation set element VI, or the pointer may be carried by an attribute of an EssentialProptery element in the video adaptation set element VI, or the pointer may be carried by a child element in a SupplementalProperty element in the video adaptation set element VI, or the pointer may be carried by an attribute of a SupplementalProperty element in the video adaptation set element VI.

Further, for example, the pointer may be carried by a value attribute or another attribute of the EssentialProptery element in the video adaptation set element VI, or the pointer may be carried by a value attribute or another attribute of the SupplementalProperty element in the video adaptation set element VI.

For another example, the pointer may be carried by an attribute of a virtual Representation element in the video adaptation set element VI, or the pointer may be carried by a child element in a virtual Representation element in the video adaptation set element VI, where the virtual Representation element does not include a media segment template element, a media segment list element, or a BaseURL element.

For another example, the pointer may be carried by a ReferencedMediaPresentation element in the video adaptation set element VI. The ReferencedMediaPresentation element is a newly extended element. That is, the newly extended element in the video adaptation set element VI may be used to carry the pointer. A name of the newly extended element that carries the pointer and that is in the video adaptation set element VI is not limited to ReferencedMediaPresentation, and may be another element name.

Optionally, in some possible implementations of the present application, a timeline of the guide media presentation may be independent of a timeline of main media presentations to which the N guide units in the guide media presentation point. An audio of a guide unit may be obtained by encoding an audio of a main media presentation, and a video of the guide unit may be obtained by encoding a video of the main media presentation. Therefore, no correlation exists between a timeline of the guide unit and a timeline of the main media presentation.

It is understandable that, functions of each functional module of the server 700 in this embodiment may be further implemented according to the method in the foregoing method embodiment. For a specific implementation process thereof, refer to the related description in the foregoing method embodiment. Details are not described herein again. The server 700 may be configured to implement any method for providing a media presentation guide in media streaming over the HTTP provided in the foregoing embodiments.

The server 700 may be a content server or another server.

It may be learned that, in the technical solution of this embodiment, an MPD that is of a guide media presentation and is generated by the server 700 describes N guide units included in the guide media presentation. Each guide unit in the N guide units may point to one main media presentation, and this is equivalent to a specific association relationship introduced between the guide unit and the main media presentation. Therefore, when a guide unit i in the N guide units is selected on a client, the client may obtain an MPD of a main media presentation j to which the guide unit i points, and may further obtain the main media presentation j according to the MPD of the main media presentation j and perform presenting. Evidently, this solution lays a basis for implementing relatively flexible switching between the guide media presentation and the main media presentation, and further lays a basis for supporting a video guide in an HTTP-based media streaming service scenario.

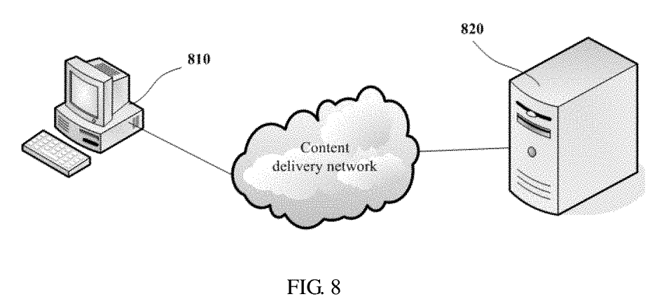

Referring to FIG. 8, an embodiment of the present application further provides a communications system, which may include a client 810 and a content server 820 having a communication connection to the client.

The client 810 is configured to obtain an MPD of a guide media presentation from the content server 820, where the MPD of the guide media presentation describes N guide units included in the guide media presentation, and N is an integer greater than 1, obtain K guide units in the N guide units from the content server 820 according to the MPD of the guide media presentation, and present the K guide units, where each guide unit in the K guide units points to one main media presentation, and presentation quality of a main media presentation to which a guide unit i in the K guide units points is higher than presentation quality of the guide unit i.

For example, the client 810 may be any client provided in the foregoing embodiments.

Content such as information exchange and an execution process between the modules in the apparatus and the system is based on a same idea as the method embodiments of the present application. Therefore, for detailed content, refer to descriptions in the method embodiments of the present application, and details are not described herein again.

An embodiment of the present application further provides a computer storage medium. The computer storage medium may store a program, and when the program is executed, some or all of the steps of any method described in the foregoing method embodiments are performed.

In the foregoing embodiments, the description of each embodiment has respective focuses. For a part that is not described in detail in an embodiment, refer to related descriptions in other embodiments.

It should be noted that to make the description brief, the foregoing method embodiments are expressed as a series of actions. However, persons skilled in the art should appreciate that the present application is not limited to the described action sequence, because according to the present application, some steps may be performed in other sequences or performed simultaneously. In addition, persons skilled in the art should also appreciate that all the embodiments described in the specification are examples of embodiments, and the related actions and modules are not necessarily mandatory to the present application.

In the several embodiments provided in this application, it should be understood that the disclosed apparatus may be implemented in other manners. For example, the described apparatus embodiment is merely an example. For example, the unit division is merely logical function division and may be other division in an actual implementation. For example, a plurality of units or components may be combined or integrated into another system, or some features may be ignored or not performed. In addition, the displayed or discussed mutual couplings or direct couplings or communication connections may be implemented using some interfaces. The indirect couplings or communication connections between the apparatuses or units may be implemented in electronic or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present application may be integrated into one processing unit, or each of the units may exist alone physically, or two or more units may be integrated into one unit. The integrated unit may be implemented in a form of hardware, or may be implemented in a form of a software functional unit.

When the foregoing integrated unit is implemented in the form of a software functional unit and sold or used as an independent product, the integrated unit may be stored in a computer-readable storage medium. Based on such an understanding, the technical solutions of the present application essentially, or the part contributing to other approaches, or all or some of the technical solutions may be implemented in the form of a software product. The software product is stored in a storage medium and includes several instructions for instructing a computer device (which may be a personal computer, a server, or a network device, and may be further a processor in a computer device) to perform all or some of the steps of the foregoing methods described in the embodiments of the present application. The foregoing storage medium includes any medium that can store program code, such as a universal serial bus (USB) flash drive, a removable hard disk, a magnetic disk, an optical disc, a read-only memory (ROM), or a random access memory (RAM).

The foregoing embodiments are merely intended for describing the technical solutions of the present application, but not for limiting the present application. Although the present application is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present application.

What is claimed is:

1. A method for providing a media presentation guide in media streaming over a Hypertext Transfer Protocol (HTTP), comprising:
obtaining, by a client, a media presentation description (MPD) of a guide media presentation, wherein the MPD of the guide media presentation describes N guide units that are part of the guide media presentation, and wherein N is an integer greater than 1;
obtaining, by the client, K guide units in the N guide units according to the MPD of the guide media presentation; and
presenting, by the client, the K guide units, wherein each guide unit in the K guide units points to one main media presentation, and wherein presentation quality of a main media presentation to which a guide unit i in the K guide units points is higher than presentation quality of the guide unit i.

2. The method according to claim 1, wherein the MPD of the guide media presentation is different from an MPD of the main media presentation to which each guide unit in the K guide units points.

3. The method according to claim 2, wherein each guide unit in the K guide units points, by pointing to the MPD, to the main media presentation described by the MPD.

4. The method according to claim 1, wherein the MPD of the guide media presentation and an MPD of the main media presentation to which each guide unit in the K guide units points are aggregated into one aggregate MPD.

5. The method according to claim 4, wherein each guide unit in the K guide units points to the main media presentation by referencing a presentation element in each aggregate MPD.

6. The method according to claim 1, wherein each guide unit in the N guide units comprises a video component, or an audio component and the video component.

7. The method according to claim 6, wherein video components that are part of different guide units in the K guide units are media representations in different video adaptation sets in K video adaptation sets, wherein selections are exclusive between the media representations in any video adaptation set in the K video adaptation sets, and wherein the selections are compatible between the different video adaptation sets in the K video adaptation sets.

8. The method according to claim 7, wherein audio components that are part of the K guide units are media representations in an audio adaptation set, wherein the audio adaptation set is different from any adaptation set in the K video adaptation sets, and wherein the selections are compatible between the audio adaptation set and the K video adaptation sets, or
wherein audio components that are part of different guide units in the K guide units are media representations in different audio adaptation sets in K audio adaptation sets, and wherein the selections are exclusive between different audio adaptation sets in the K audio adaptation sets.

9. The method according to claim 8, wherein a media representation element in an audio adaptation set element comprises a region description of a media representation, which is described by the media representation element, in an associated guide unit in the guide media presentation.

10. The method according to claim 9, wherein an association relationship exists between:
media representations described by media representation elements comprising a same region description; or
adaptation sets described by adaptation set elements comprising the same region description.

11. The method according to claim 9, wherein the region description is a spatial relationship description.

12. The method according to claim 7, wherein the MPD of the guide media presentation comprises K video adaptation set elements, wherein the K video adaptation set elements correspond to the K video adaptation sets on a one-to-one basis, wherein the K video adaptation set elements comprise descriptor elements (Cis), wherein selections are compatible between video adaptation sets described by video adaptation set elements meeting a specified common condition in the K video adaptation set elements, and wherein the specified common condition is that the Cis that are part of the video adaptation set elements have same element names and method identification attributes (schemeIdUri).

13. The method according to claim 12, wherein a Ci describes a case in which a media representation in a video adaptation set described by a video adaptation set element comprising the Ci is a component of the guide media presentation.

14. The method according to claim 12, wherein a Ci describes a role of a media representation, in a video adaptation set corresponding to a video adaptation set element comprising the Ci, in the guide media presentation.

15. The method according to claim 13, wherein the Ci is a role description (Role) element, an essential property element, or a supplemental property element.

16. A client, comprising:
a processor; and
a memory coupled to the processor and configured to store a code or an instruction, wherein when executed, the code or the instruction in the memory causes the processor to be configured to:
obtain a media presentation description (MPD) of a guide media presentation, wherein the MPD of the guide media presentation describes N guide units that are part of the guide media presentation, and wherein N is an integer greater than 1;
obtain K guide units in the N guide units according to the MPD of the guide media presentation; and
present the K guide units, wherein each guide unit in the K guide units points to one main media presentation, and wherein presentation quality of a main media presentation to which a guide unit i in the K guide units points is higher than presentation quality of the guide unit i.

17. The client according to claim 16, wherein the MPD of the guide media presentation is different from an MPD of the main media presentation to which each guide unit in the K guide units points.

18. The client according to claim 17, wherein each guide unit in the K guide units points, by pointing to the MPD, to the main media presentation described by the MPD.

19. The client according to claim 16, wherein the MPD of the guide media presentation and an MPD of the main media presentation to which each guide unit in the K guide units points are aggregated into one aggregate MPD.

20. The client according to claim 19, wherein each guide unit in the K guide units points to the main media presentation by referencing a presentation element in each aggregate MPD.
